(19) United States
(12) Patent Application Publication
(10) Pub. No.: US 2020/0372436 A1
(43) Pub. Date: Nov. 26, 2020

(54) INTELLIGENT SCHEDULING

(71) Applicant: Kronologic, Inc., Austin, TX (US)

(72) Inventors: Christopher Sean Anthony Lee, Austin, TX (US); Benjamin Duffy Parker, Round Rock, TX (US); Aaron Jay Bollinger, Austin, TX (US); James Edward Allison, III, Austin, TX (US)

(21) Appl. No.: 16/880,977

(22) Filed: May 21, 2020

Related U.S. Application Data
(60) Provisional application No. 62/850,917, filed on May 21, 2019.

(51) Int. Cl. G06Q 10/06; G06Q 10/10

(52) U.S. Cl. CPC G06Q 10/063112; G06Q 10/1097; G06Q 10/1095; G06Q 10/063114

(57) ABSTRACT

Techniques described herein are directed to a scheduling platform configured to intelligently assign work to a representative of an organization. A representative may include an employee of the organization or other entity configured to receive work assignments from the organization, such as a contractor, or the like. The scheduling platform may determine a task to be performed (e.g., work assignments) and may identify one or more representatives associated with the task. The one or more representatives may include those available and/or qualified to perform the task. The scheduling platform may identify a representative of the one or more representatives to conduct the task and may cause an appointment for the task to be presented on a calendar at a computing device associated with the representative.

### PRIORITY

This application claims the benefit of priority to U.S. Provisional Application Ser. No. 62/850,917, filed May 21, 2019 and entitled “Intelligent Scheduling,” the entire contents of which are incorporated herein by reference.

### BACKGROUND

Many organizations utilize workload distribution systems to assign work to representatives associated with a respective organization. Conventional workload distribution systems assign work on a rotating schedule, such that a first assignment may be associated with a first representative, a second assignment may be associated with a second representative, and so on until each representative has an assignment, at which point the system may assign the next assignment to the first representative, and so on. These conventional systems may assign work consecutively in a “round robin” style format, regardless of representative schedules and/or expertise. As such, the conventional workload distribution may be inefficient and unbalanced across an organization.

Further, in many organizations, work assignments involve meetings between a representative of the organization and another person, such as a client. Traditionally, meeting times are coordinated by the assigned representative and the other person, such as via electronic mail. For example, a representative may tentatively reserve multiple potential meeting times and provide the times to the other person for selection of a particular time for the meeting. However, this traditional system requires that the representative maintain the reserved times until the other person selects the particular time, which may take hours, days, and in some cases, weeks. Because the times are reserved on a schedule associated with the representative until a particular time is selected, this traditional scheduling system results in inefficiencies in scheduling and representative workload, as the representative may not schedule other meetings during the reserved times.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to schedule appointments for tasks, as described herein.

FIG. 2 illustrates example scheduling models usable to schedule appointments for tasks, utilizing the techniques described herein.

FIG. 3 illustrates a representation of historical performances of two representatives during a time period, utilizing the techniques described herein.

FIG. 4 illustrates an example process for identifying a representative for task assignment, utilizing the techniques described herein.

FIG. 5 illustrates an example process for receiving a task from a contact and identifying a representative for task assignment, utilizing the techniques described herein.

FIG. 6 illustrates an example process for scheduling an appointment for a task to be completed based on a task type associated therewith, utilizing the techniques described herein.

FIG. 7 illustrates an example process for identifying a representative to complete a task based on a performance score associated therewith, utilizing the techniques described herein.

FIG. 8 illustrates an example process for assigning a task to a representative based on a performance score associated therewith, utilizing the techniques described herein.

FIG. 9 illustrates an example process for determining a task to be assigned to a representative, utilizing the techniques described herein.

FIG. 10 illustrates an example process for automatically scheduling a meeting on a calendar of a representative, utilizing the techniques described herein.

FIG. 11 illustrates an example process for modifying a meeting time associated with a tentatively scheduled meeting based on input from a representative, utilizing the techniques described herein.

FIG. 12 illustrates a process for determining whether to modify an invitation associated with a task, utilizing the techniques described herein.

FIG. 13 is a block diagram illustrating an example system of a service computing device usable to implement example techniques described herein.

### DETAILED DESCRIPTION

Techniques described herein are directed to a scheduling platform configured to intelligently assign work to a representative of an organization. A representative may include an employee of the organization or other entity configured to receive work assignments from the organization, such as a contractor, or the like. The scheduling platform may analyze calendars and/or representative characteristics associated with a group of representatives, such as individual expertise, and intelligently select the representative to optimize scheduling efficiencies in the organization. The scheduling platform may thus improve operational efficiencies within the organization.

The scheduling platform may identify a task to be assigned. The task may include a work assignment for a representative to complete. In some examples, the task may include conducting a meeting with a contact. The contact may include a person outside the organization (e.g., not an employee or contractor thereof) or inside the organization (e.g., an employee or contractor thereof) associated with the task. In various examples, the scheduling platform may identify the task based on receiving a communication from the contact, such as an email, a notification of interest, a telephone call, or the like. In such examples, the communication may comprise a request associated with one or more services provided by the organization. For example, a contact may submit a request for a demonstration of capabilities (e.g., demo) from an organization. The scheduling platform may receive the request and determine that the request includes the task of conducting a demo. The scheduling platform may identify a representative of the organization to conduct the task and may cause an appointment for the task to be presented on a calendar associated with a representative computing device.

In some examples, the scheduling platform may identify the task based on one or more organizational preferences stored in association with an organizational profile in a datastore. In such an example, the scheduling platform may access the organizational preferences to determine a task to be assigned. For example, an organization may have a preference for sales representatives to conduct quarterly meetings with customers. The scheduling platform may determine the preference and may identify that a task associated with a quarterly meeting with a particular customer is due to be scheduled.

Techniques described herein improve on conventional workload distribution systems. As discussed above, conventional systems merely assign tasks to employees on a rotating schedule, without taking into account an employee's schedule or expertise. These conventional systems can lead to inefficient and unbalanced workload, as experienced, efficient, and high performing employees may complete task faster than other, less experienced employees, and may have a significant amount of white space or unscheduled time on their calendars. The unscheduled time may result in lost revenue for an organization. The techniques described herein determine a workload balance based on availability and/or performance of the employee in completing tasks. As such, the techniques described herein improve the current workload distribution systems by efficiently balancing workloads of employees and optimizing an organizational efficiency and output.

Additionally, techniques described herein improve current scheduling systems. As discussed above traditional scheduling systems require a representative assigned to conduct a meeting to schedule a time with another person (e.g., a contact) for the meeting. However, this traditional system requires that the representative maintain the reserved times until the other person selects the particular time, which may take hours, days, and in some cases, weeks. Because the times are reserved on a schedule associated with the representative until a particular time is selected, this traditional scheduling system results in inefficiencies in scheduling and representative workload, as the representative may not schedule other meetings during the reserved times. The techniques described herein provide an automated scheduling system that may determine an open time and coordinate the time with the other person, tentatively holding the meeting time on the calendar of the representative. The scheduling platform may confirm the time and may present an appointment therefor on the representative's calendar. Accordingly, the techniques described herein improve the efficiency in scheduling over traditional systems, by coordinating meeting times automatically and out of view of the employee until the meeting is confirmed. Moreover, routing logic, machine learning, and the like can be used to dynamically identify a representative of a group of representatives to which a task will be assigned such as to efficiently and effectively balance task assignments across an organization. Thus, techniques described herein improve an existing technological process of appointment scheduling.

Furthermore, techniques described herein improve a computing system of an employee. As discussed above, traditional scheduling systems require a representative assigned to conduct a meeting to schedule a time with another person for the meeting. Oftentimes, the representative may have to send multiple messages with the other person to determine a time for the meeting, wasting time and computing resources associated with a computing device of the representative. The scheduling platform described herein may automate the scheduling process remotely (e.g., on a service computing system remote from the computing system), thereby improving the computing system of the representative by reducing an amount of resources (e.g., processing power, memory, etc.) required thereof to schedule the appointment. Furthermore, the scheduling platform described herein may reduce a total amount of network traffic by reducing a number of messages transmitted between a representative and another person to determine a time for the meeting.

These and other aspects are described further below with reference to the accompanying drawings. The drawings are merely example implementations and should not be construed to limit the scope of the claims. For example, while examples are illustrated in the context of a scheduling appointments for a representative of an organization, the techniques described herein may also be applied to any other type of scheduling.

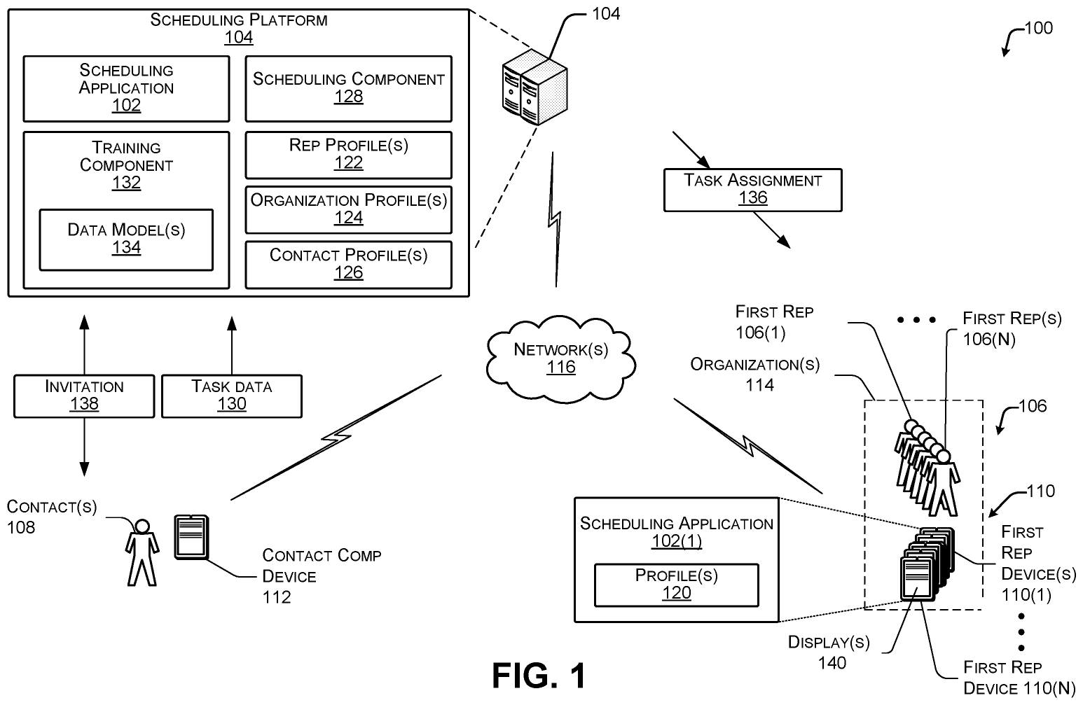

FIG. 1 is a schematic view of an example system 100 usable to implement the techniques described herein to provide automatic scheduling of appointments for tasks via a scheduling application 102. The system 100 (e.g., scheduling platform) may include a scheduling platform 104 configured to access and modify the scheduling application 102, such as to schedule appointments for tasks between one or more representatives 106(1) . . . 106(N) (collectively “representatives,” illustrated as reps for brevity) and one or more contacts 108(1) . . . 108(M) (collectively “contacts”). As illustrated, the representative(s) 106 may each have associated therewith a respective representative computing device 110(1) . . . 110(0) (“rep comp device 110”) and the contact(s) may each have associated therewith one or more contact computing devices 112. In various examples, the representative(s) 106 may include employees, contractors, or the like of an organization 114. In such examples, one or more of the representative computing device(s) 110 may include a computing device associated with an organization.

Each of the representative computing devices 110 and the contact computing device(s) 112 include one or more processors and memory storing computer executable instructions to implement the functionality discussed herein attributable to the various computing devices. In some examples, the representative computing devices 110 and the contact computing device(s) 112 may include desktop computers, laptop computers, tablet computers, mobile devices (e.g., smart phones or other cellular or mobile phones, mobile gaming devices, portable media devices, etc.), or other suitable computing devices. The representative computing devices 110 and the contact computing device(s) 112 may execute one or more client applications, such as a web browser (e.g., Microsoft Windows Internet Explorer, Mozilla Firefox, Apple Safari, Google Chrome, Opera, etc.) or a native or special-purpose client application (e.g., scheduling applications, email applications, etc.), to access and view content over the network 116.

The network 116 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the representative computing devices 110 and/or the contact computing device(s) 112 may access the scheduling platform 104 and/or communicate with one another.

The scheduling platform 104 may include one or more servers or other computing devices, any or all of which may include one or more processors and memory storing computer executable instructions to implement the functionality discussed herein attributable to a scheduling platform. The scheduling platform 104 may access a first instance of a scheduling application 102(1) on the first rep device(s) 110, to facilitate scheduling an appointment for a task between the associated representative 106 and the contact 108. In some examples, the first instance of the scheduling application 102(1) may include a user interface via which the associated representative 106 may view appointments on the calendar associated therewith. The calendar may include appointments automatically scheduled by the scheduling platform 104 and/or appointments scheduled by the representative 106

In some examples, the scheduling platform 104 may manage the scheduling application 102. In such examples, the scheduling platform 104 may include the scheduling application 102. In some examples, the scheduling application 102 located on the scheduling platform 104 may include an application programming interface configured to communicate with the first instance of the scheduling application 102(1), such as to add create, modify and/or delete appointments on a calendar of a representative via the first instance of the scheduling application 102(1).

In various examples, the rep device(s) 110 may store one or more profiles 120 associated with the representative and/or the organization. Similarly, the scheduling platform 104 may store one or more representative profiles 122 and/or one or more organization profiles 124. Representative profiles 122 may include one or more characteristics associated with one or more representatives 106. The characteristics associated with a representative 106 may include a start time for a first task to be scheduled, a end time for a last task of the day to be started and/or finished (e.g., last task to start no later than 4 pm, last task to end no later than 4 pm, etc.), times for one or more breaks (e.g., lunch, coffee, smoke, etc.), maximum and/or minimum times to be scheduled for tasks (e.g., for each tasks based on task type, for all tasks, etc.), task scheduling preferences (e.g., maximum two tasks scheduled in a row for a representative, 15-minute break between scheduled tasks, maximum 5 tasks to be completed in a day, etc.), or the like. In some examples, the representative profiles 122 may include historical performance data associated with a performance of the representative 106 at the organization and/or at other organizations. The historical performance data may include statistics associated with completing a task, converting a task to an opportunity (e.g., demonstration to a potential sale), converting an opportunity into a closed sale, average revenue per task performed, average profit per task performed, average cost per task performed, and the like.

Organization profiles 124 may include one or more characteristics associated with one or more organizations 114. The characteristic(s) associated with the organization may include one or more task settings associated with requested tasks to be automatically scheduled (e.g., requested tasks, periodic tasks, etc.), one or more task scheduling preferences (e.g., maximum two tasks scheduled in a row for a representative, 15-minute break between scheduled tasks, maximum 5 tasks to be completed in a day, etc.), scheduling model preferences (e.g., overall model preferences, model preferences based on task type, etc.), performance characteristics (e.g., performance based on tasks completed per hour, tasks completed per day, revenue per task, etc.), and the like.

Additionally, in some examples, the scheduling platform 104 may include one or more contact profiles 126 associated with a contact. The contact may include a person outside the organization (e.g., not an employee or contractor thereof) associated with the task. In some examples, the contact may be a known entity (e.g., previous contact). In such examples, the scheduling platform may import contact data, such as from a contact profile 126 stored in a data store. The contact data may include one or more characteristics associated with the contact (e.g., name, position, address, electronic mail address, telephone number, social media handle, preferences, etc.), previous tasks associated with the contact, representatives assigned to the previous tasks, revenue collected from the contact 108 and/or an organization associated therewith, a position of the contact at the organization associated therewith (e.g., Chief Executive Officer (CEO), Chief Financial Officer (CFO), President, manager, etc.) and the like. In examples in which the contact is not a known entity (e.g., new contact), the scheduling platform may configure data collection fields to collect data from the contact. In such examples, responsive to receiving the data from the contact, the scheduling platform may generate a contact profile 126 associated with the (new) contact.

In various examples, the scheduling platform 104 may determine a task to be performed. In some examples, a scheduling component 128 of the scheduling platform 104 may determine the task based on one or more task settings, such as those stored in an organization profile 124 associated with an organization 114. In such examples, the scheduling platform 104 may access the organizational profile 124 associated with the organization 114 to determine the task settings. The task settings may include a preference of the organization 114 to have a task associated with one or more contacts 108 of the organization 114 completed at a designated time. In some examples, the task may include a single task to be performed by a representative 106 of the organization 114. In some examples, the task may include a reoccurring task, such as one to be performed at periodic intervals (e.g., monthly, quarterly, annually, bi-annually, etc.). In some examples, the scheduling component 128 may determine that a current time is within a threshold time (e.g., 5 days, two weeks, one month, etc.) associated with scheduling a first task of the reoccurring tasks. In such examples, the scheduling platform may identify a representative 106, such as representative 106(1), to perform the task and may determine to schedule the task between a representative 106(1) and the associated contact 108. For example, an organization 114 may send a task setting to the scheduling platform 104, the task setting including a reoccurring task of performing quarterly check-in meetings with customers (e.g., contacts 108). The scheduling platform may determine that a current time is within a threshold time of the next quarter and determine to schedule the task between a representative 106(1) and the associated contact 108.

In some examples, the scheduling component 128 may determine the task to be performed based on input from a contact computing device 112 associated with a contact 108. In some examples, the input may include an indication of inefficient operation associated with an application (e.g., native application on the contact computing device 112, web application accessed via a web browser) and/or the operation of a unit of hardware provided by the organization. The indication of inefficient operation may include an indication to the scheduling component that the operator (e.g., contact) does not know how to properly operate the application and/or unit of hardware. For example, the indication of inefficient operation may include an indication that the operator “rage clicks” (e.g., a number of clicks per second exceeds a threshold number) on a selectable option on a page. Based on the indication of inefficient operation, the scheduling component 128 may determine that an enablement meeting task should be scheduled between the operator and a representative of the organization associated with the application, to assist the operator in determining an efficient operation of the application and/or to improve a user experience therewith.

In some examples, the scheduling component 128 may receive task data 130 from the contact computing device 112 associated with a contact 108. The task data 130 may include a request for a task to be performed by a representative 106 of the organization 114. For example, the task data 130 may include a request for a demonstration of capabilities of a product provided by the organization 114. The task data 130 may be transmitted via a communication from the contact 108 (e.g., via email, text message, etc.) and/or may be received via data collection fields associated with an application of the contact computing device (e.g., on a web application accessed via a web browser, native application, etc.). For example, the contact 108 may launch an application associated with the organization 114 on a contact computing device 112 and may submit a request for assistance with a software program provided by the organization 114. The request may include task data 130 describing the problem the contact 108 is experiencing. In some examples, the task data 130 may include an urgency associated with the request (e.g., level of importance, etc.). For example, the task data 130 may include a tier 1 level request for information technology (“IT”) support.

In various examples, the scheduling component 128 may determine one or more task characteristics associated with the task. The task characteristic(s) may include a task type (e.g., type of meeting requested, such as a demonstration, a check-in, enablement meeting, help desk ticket, etc.), a service associated with the task (e.g., update a product, fix a bug in software, stock shelves at a brick and mortar store, etc.), a time associated with the task (e.g., time created, time for completion, etc.), contact data associated therewith, level of importance, or the like. In various examples, scheduling component 128 may determine the task characteristic(s) based on the task data 130 and/or the task settings associated with an organization 114. In various examples, the scheduling component 128 may associate the task characteristic(s) with a contact 108. In at least one example, the scheduling platform may determine a task type (e.g., meeting type) based on the contact data and/or the source of the task (e.g., task settings) and may associate the meeting type with the contact 108, such as in the contact profile 126.

The scheduling platform may identify a group of representatives (e.g., a team) associated with the organization that may perform the task. In various examples, the group of representatives may be identified based on one or more rules associated with the scheduling platform. The rule(s) may be based on a type of task, a characteristic of the task, new contact, existing contact, contact preferences, representative characteristics (e.g., type of representative, area of expertise, etc.), pre-defined representative teams (e.g., predefined groups of representatives), or the like. In some examples the one or more rules may be defined by the organization, such as in organizational preferences stored in an organization profile 124. In some examples, the rule(s) may be determined at an initialization stage of the scheduling platform with the organization. In such examples, the organization may set an initial set of preferences. In some examples, the rule(s) may be determined after initialization, such as after operating the scheduling platform for a time and identifying rules to add or remove to the one or more rules. In some examples, the rules may be determined based on one or more machine learned techniques. In such examples, the scheduling platform 104 may include a training component 132 configured to train one or more data models 134 to determine one or more rules to maximize efficiencies associated with generating the group of representatives. In various examples, the training component 132 may utilize training data associated with tasks, task types, opportunities resulting from tasks, revenue resulting from opportunities, profit resulting from sales, times associated with the tasks, experience of the representative 106 performing the task, level of education and/or qualifications associate with the representative 106, and/or other information related to previously performed tasks, to train the data model to output one or more representatives 106 associated with an optimal efficiency.

In various examples, the group of representatives may be associated with the task and/or type of task (e.g., meeting type) based on the rule(s). In various examples, the group of representatives 106 may be determined based on the task type associated with the task. In some examples, the group of representatives 106 may be associated with particular tasks, based on qualifications, employment positions (e.g., sales person, IT support, etc.), experience at an organization, and the like. For example, sales people may be assigned to perform demonstrations of product capabilities to potential and existing customers (e.g., contacts 108). Based on determining that a task includes a demonstration, the scheduling platform 104 may identify a group of representatives 106 including sales people capable of performing the task.

In various examples, the group of representatives 106 may be determined based on performance of the representatives 106 in an organization 114. In some examples, the scheduling platform 104 may access historical performance data associated with representatives 106 such as that stored in a representative profile 122. The historical performance may include statistics associated with completing a task, converting a task to an opportunity (e.g., demonstration to a potential sale), converting an opportunity into a closed sale, average revenue per task performed, average profit per task performed, average cost per task performed, and the like. In some examples, the scheduling platform 104 may determine a performance score associated with each representative 106 of an organization. In some examples, the performance scores may be stored in the representative profiles 122 and/or the organization profiles 124. In some examples, the performance scores may be associated with a task type. For example, a first representative may have an associated first performance score associated with a first task and a second performance score associated with a second task. The scheduling platform may determine that the first representative 106(1) performs better at the first task than the second task based on a determination that the first performance score is greater than the second performance score.

In some examples, the group of representatives 106 may be determined based on performance of a representative 106(1) relative to an average performance of representatives in an organization 114. In some examples, the scheduling platform 104 may determine an average performance of representatives 106 across the organization 114. In some examples, the scheduling platform 104 may compare the performance of each representative 106 to the average performance. In some examples, the scheduling platform 104 may identify the group of representatives 106 as those including a performance equal to or greater than the average performance score. In some examples, the scheduling platform 104 may identify the group of representatives 106 as those including a performance score that is a threshold amount above the average score.

In some examples, the group of representatives 106 may be determined based on performance of a representative 106(1) as compared to the performance of other representatives 106 in the organization 114. In some examples, the scheduling platform 104 may determine a performance score associated with each representative 106 in the organization 114. In some examples, the scheduling platform 104 may identify a first group of representatives 106 as those having an associated performance score equal to or greater than a first threshold, a second group of representatives 106 as those having a performance score equal to or less than the first threshold and equal to or greater than a second threshold, and a third group of representatives 106 as those having a performance score equal to or less than the second threshold. In some examples, the group of representatives 106 may be selected based on the identified first, second, or third group. For example, the scheduling component 128 of the scheduling platform 104 may determine that task data 130 associated with a first task indicates that the first task is of low urgency and low difficulty. The scheduling component 128 may determine the third group of representatives 106 for determining a representative 106 for task assignment. For another example, the scheduling component 128 of the scheduling platform 104 may determine that task data 130 associated with a second task indicates that the second task is of high urgency and includes a high profile contact 108 (e.g., CEO of another organization, high revenue client, etc.). Based on a determination that the second task is high urgency and involves a high profile contact 108, the scheduling component 128 may determine the first group (e.g., best performing) of representatives 106 for task assignment.

In some examples, the scheduling component 128 may determine the group of representatives 106 based on a scheduling availability to perform the task. In some examples, the scheduling availability may be defined by a work schedule. In such examples, the group of representatives 106 may include representatives 106 that are available during particular hours and/or particular days of the week. In some examples, the scheduling availability may be defined based on a general calendar availability over a pre-determined period of time. In such examples, the performance capability may include representatives that don't have calendar days blocked out over the period of time. For example, the scheduling component 128 may determine that a representative 106 of the organization 114 may start a two-week vacation the following day. Based on the determination of the pending vacation and calendar unavailability, the scheduling component 128 may not include the representative 106 in the group of representatives 106.

In some examples, based on identifying the group of representatives 106, the scheduling component 128 may identify a representative 106 for the task assignment 136 (e.g., appointment associated with performing the task, conducting the meeting, etc.). In some examples, the representative 106 may be determined based on a performance score associated therewith. For example, the representative 106 with a first (high) score associated with a particular task type associated with the task may receive the task assignment 136. For another example, the representative 106 with a second (low) score associated with a particular task type may receive the task assignment 136, such as to improve the performance score of the representative through experience. In some examples, the performance-based task assignment 136 may be determined based on one or more organizational preferences, such as those stored in the organizational profile 124.

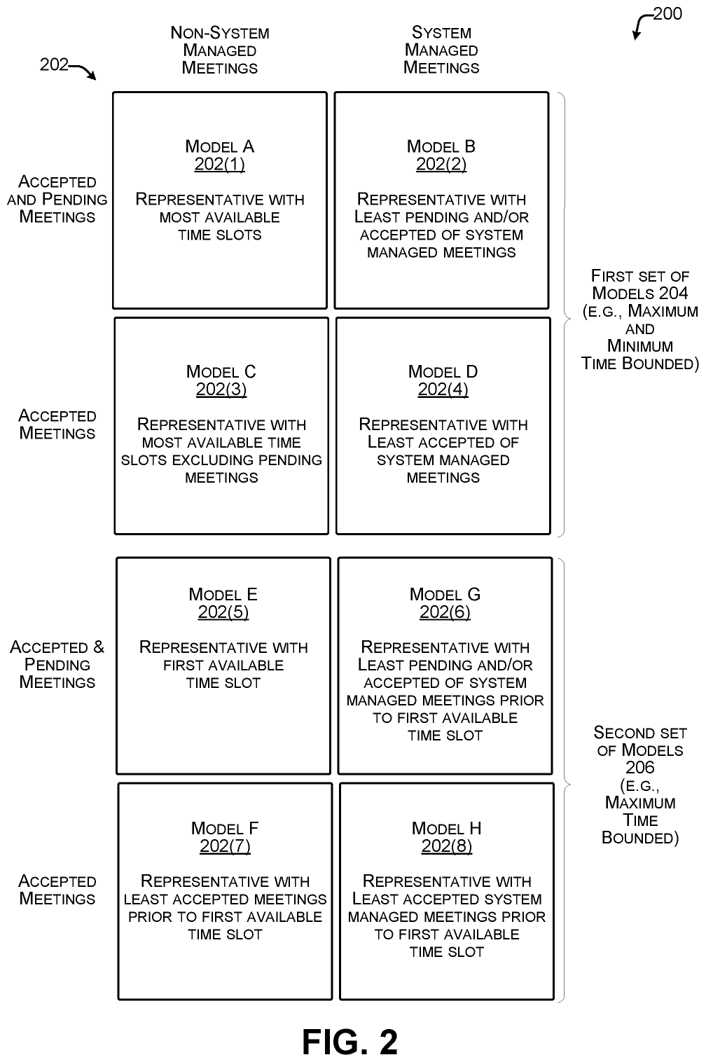

In various examples, based on identifying the group of representatives 106, the scheduling component 128 may identify a representative to be assigned the task based on one or more scheduling models (illustrated in FIG. 2). In various examples, the scheduling model(s) may be based on a number of system generated and/or non-system generated meetings. In some examples, the scheduling model(s) may be based on a number of pending and/or accepted meetings. In various examples, the scheduling model(s) may be determined based on the organizational preferences stored in the organizational profile 124 associated with the organization 114. In such examples, the scheduling model(s) may be defined during the initialization stage and/or updated at a later time. The scheduling models may represent routing logic utilized by the scheduling component 128 to determine the representative to which the task will be assigned.

In some examples, the scheduling component 128 may identify the representative 106 for task assignment and may identify a time associated with the task. In some examples, the scheduling component 128 may block the time in a calendar associated with the representative 106, such as via the first instance of the scheduling application 102(1). In some examples, the time block may be presented to the representative 106 as a pending task. In some examples, the time block may be hidden from view of the representative 106 (e.g., not presented). In various examples, the scheduling component 128 may send an invitation 138 to an appointment associated with the task assignment 136 to the contact computing device 112. In some examples, the contact 108 may accept the time associated with the invitation 138. In such examples, the scheduling component 128 may cause the task assignment 136 to be presented as an appointment on the calendar of the representative, such as via the first instance of the scheduling application 102(1).

In various examples, the contact 108 may receive the invitation 138 and may decline (e.g., reject) the invitation. In some examples, a rejection of the invitation may include an indication that the time is not available for the contact 108. In some examples, the scheduling component 128 may identify a second time on the calendar of the representative for scheduling the task assignment. In such examples, the scheduling component 128 may block the second time on the calendar of the representative and unblock the original time. In some examples, the scheduling component 128 may send a second invitation 138 to the contact computing device 112 including the second time. In various examples, the scheduling component 128 may continually modify the times associated with the task assignment 136 until receiving an indication of acceptance of an invitation 138 from the contact computing device 112. Responsive to receiving the indication of acceptance, the scheduling component 128 may cause the task assignment to be presented as an appointment on the calendar of the representative. In some examples, the appointment may include an indication that the appointment was automatically generated by the scheduling component 128 (i.e., in lieu of a representative generated appointment).

In some examples, prior to receiving the indication of acceptance of the invitation 138, the scheduling component 128 may receive an indication from the representative device 110, such as via the first instance of the scheduling application 102(1), that the representative 106 is scheduling or has scheduled an appointment at a time associated with a pending invitation 138 (e.g., invitation sent to the contact 108 and not yet accepted).

In some examples, based on a determination that the representative is attempting to schedule another appointment at the time associated with the pending appointment (e.g., appointment for which the invitation 138 has been sent, but an acceptance has not yet been received), the scheduling component 128 may cause a notification to surface on a user interface of the first instance of the scheduling application 102(1). The notification may provide an indication that an invitation is pending at the time and that there may be a conflict. In some examples, the notification may provide a means by which the representative 106 may accept the pending appointment, such as by choosing another time for the representative 106-generated appointment. In some examples, the notification may provide a means by which the representative may ignore the pending appointment. Based on receiving an indication that the representative has ignored the pending appointment, the scheduling component 128 may attempt to reschedule the task assignment 136.

In various examples, based on the determination that the representative has ignored the pending appointment and/or scheduled another appointment at the time, the scheduling component 128 may determine a second time available for the appointment. In some examples, the scheduling component 128 may modify the invitation 138 to reflect the second time. In some examples, the scheduling component 128 may determine to modify the invitation based on a determination that the second time is within a threshold time of the original time (e.g., within 30 minutes, 1 hour, etc.). In some examples, based on a determination that the second time is more than the threshold time away from the original time, the scheduling component 128 may send an updated invitation 138 with the second time. In some examples, the scheduling component 128 may revoke the invitation 138 based on a determination that the time is no longer available on the calendar of the representative 106.

In various examples, the scheduling component 128 may determine that the identified representative does not have another time on the calendar for scheduling the task assignment 136. In such examples, the scheduling component 128 may identify another representative 106 to perform the task assignment 136. In some examples, the scheduling component 128 may modify the invitation 138 to reflect the change in representative. In some examples, the scheduling component 128 may send an updated invitation 138 including the updated representative. In some examples, the updated invitation 138 may include a message about the modified time and/or an inquiry as to whether the contact wants to still conduct the task with the representative 106. For example, the updated invitation may include a message “do you still want to schedule this?” or “please note the updated time based on representative availability.”

In various examples, a representative 106, such as representative 106(1), may view one or more task assignments 136 (e.g., accepted and/or pending tasks, system-managed workloads) and/or other appointments (e.g., appointments scheduled by the representative, non-system-managed workloads) on a calendar associated therewith via the first instance of the scheduling application 102(1). The calendar may be presented via a display 140 associated with a respective representative computing device 110. Depending on a type of computing device used as the representative computing device 110, the display(s) 140 may employ any suitable display technology. For example, the display(s) 140 may include liquid crystal displays, a plasma displays, a light emitting diode displays, OLED (organic light-emitting diode) displays, electronic paper displays, or any other suitable type of displays able to present digital content thereon. In some examples, the display(s) 140 may have a touch sensor associated therewith to provide a touchscreen display configured to receive touch inputs for enabling interaction with a graphical user interface presented on the display(s) 140. Accordingly, implementations herein are not limited to any particular display technology.

In some examples, the representative 106(1) may add, delete, and/or modify appointments scheduled by the representative 106(1) via the first instance of the scheduling application 102(1). In some examples, the representative 106(1) may modify appointments scheduled by the scheduling platform 104, such as to add notes and/or comments to the calendar invitation. In some examples, the representative may delete appointments scheduled by the scheduling platform 104, such as if a conflict arises with the appointment. In such examples, the communication platform may receive, from the first representative device via the first instance of the scheduling application 102(1), an indication that the appointment has been deleted. In various examples, responsive to receiving an indication that the appointment has been deleted, the scheduling platform 104 may identify another representative 106, such as representative 106(n), to perform the task. In some examples, responsive to receiving an indication that the appointment has been deleted, the scheduling platform 104 may notify the associated contact 108 of the change to the appointment.

FIG. 2 illustrates a table 200 of example scheduling models 202 usable to schedule appointments for tasks, utilizing the techniques described herein. A first set of models 204 may represent models including a pre-determined range of times (e.g., minimum and maximum time bounded) and a second set of models 206 including a pre-determined maximum time (e.g., maximum time bounded). In some examples, the pre-determined range of times and/or the maximum time may be determined based on organizational preferences. In such examples, times associated with each model (e.g., A-H) may be determined by the organization, such as organization 114. In various examples, the times may be dynamically determined, such as based on the characteristic(s) associated with the task and/or the contact, characteristics associated with the group of representatives (e.g., group size, average experience, etc.), and/or any other factors that may impact the maximum and/or minimum bounded times. In various examples, a scheduling platform, such as scheduling platform 104, may utilize routing logic to determine a representative for task assignment. The routing logic may consider system-managed workloads (e.g., tasks, such as meeting invitations generated by the scheduling platform) and/or non-system-managed workloads (e.g., tasks, such as meeting invitations generated by another source, such as the representative). Though illustrated as eight models. Models A-H are not intended to be limiting and any other number of models and/or model identifiers are contemplated.

A first model 202(1) (e.g., Model A) may represent the scheduling platform selecting a representative for task assignment based on an amount of time available on a calendar (e.g., schedule) associated therewith. The amount of time available may correspond to a number of available time slots (e.g., pre-determined time intervals) in a calendar associated with the representative over a defined time period (e.g., 2 days, 5 days, 10 days, etc.) The defined time period may be defined by the organization (e.g., organizational preferences) and/or the scheduling platform. In some examples, the defined time period may be determined utilizing one or more machine learning algorithms trained to identify a time period for considering available time slots such as to maximize efficiencies and workload balance. In such examples, one or more data models may be trained to output the optimized time period associated with a maximized efficiency and/or workload balance between representatives of a group of representatives.

According to the logic in the first model 202(1), the number of available time slots may include time slots that do not include meeting requests that are pending or accepted. The meeting requests may include tasks previously assigned to a representative, such that a particular time associated therewith may be reserved in a calendar (e.g., schedule) associated with the representative. A meeting request is considered “accepted” based on receiving a response from a contact to which the meeting request was sent, confirming the meeting invitation at a particular time. A meeting request is considered “pending” if the contact to which the meeting request was sent has not accepted, but has also not declined, the meeting invitation. In various examples, the scheduling platform may compare the number of time slots not reserved with a pending or accepted task associated with each representative of the group and may select the representative with the greatest number of available time slots for task assignment.

In various examples, the scheduling platform may determine that two or more representatives have a same number of available time slots. In some examples, the scheduling platform may select the representative based on random or sequential task routing. Random task routing may include randomly selecting the representative from the subset of representatives having a same amount of time available. Sequential task routing may include determining an order associated with the representatives and assigning the task to a representative based on the order. For example, representatives in a group of representatives may be assigned a sequential order 1-10. The scheduling platform may determine that representatives 1, 2, and 3 may have an equal amount of time available and may select representative 1 for task assignment based on the order. In such an example, representative 2 may be selected for task assignment for a subsequent task, and so on. In some examples, based on a determination that two or more representatives have a same number of available time slots, the scheduling platform may determine a representative based on performance scores associated therewith, such as those described above. In some examples, the scheduling platform may select a highest performing representative of the two or more representatives. In some examples, the scheduling platform may select a lowest performing representative of the two or more representatives, such as to provide an opportunity for the representative to get experience and increase an associated performance score.

A second model 202(2) (e.g., Model B) may represent the scheduling platform selecting a representative for task assignment based on an amount of time available (e.g., number of time slots) over the defined time period that do not include accepted meeting invitations (e.g., time slots with no meeting or a pending meeting). The routing logic associated with the second model 202(2) may consider time slots in which a meeting invitation is pending as available time slots. In various examples, the scheduling platform may compare the amounts of time available associated with each representative of the group and may select the representative with the greatest number of available time slots (e.g., most time available) is selected for task assignment. In examples in which two or more representatives have a same amount of time available, the scheduling platform may select the representative based on random or sequential task routing.

A third model 202(3) (e.g., Model C) may represent the scheduling platform selecting a representative for task assignment based on a density of pending and/or accepted system-managed workloads over the defined time period. In some examples, the scheduling platform may determine a number of pending and accepted system-managed workloads on calendars associated with representatives of the group over the defined time period. In such examples, the scheduling platform may compare the densities of system-managed workloads associated with the representatives in the group and select the representative with the lowest density (e.g., lowest number) of pending and accepted system-managed workloads during the defined time period. In examples in which two or more representatives have a same amount of time available, the scheduling platform may select the representative based on random or sequential task routing.

A fourth model 202(4) (e.g., Model D) may represent the scheduling platform selecting a representative for task assignment based on a density of accepted system-managed workloads over the defined time period. In some examples, the scheduling platform may determine a number of accepted system-managed workloads on calendars associated with representatives of the group over the defined time period. In such examples, the scheduling platform may compare the densities of system-managed workloads associated with the representatives in the group and select the representative with the lowest density (e.g., lowest number) of accepted system-managed workloads during the defined time period. In examples in which two or more representatives have a same amount of time available, the scheduling platform may select the representative based on random or sequential task routing.

A fifth model 202(5) (e.g., Model E) may represent the scheduling platform selecting a representative for task assignment based on a first available time slot without a pending or accepted task. According to the logic in the fifth model 202(5), the scheduling platform may compare the schedules associated with each representative of the group and select the representative with the first available time slot that does not include a pending or accepted task. In examples in which two or more representatives have a same first available time slot (e.g., at 3 pm on a same date), the scheduling platform may select the representative based on random or sequential task routing.

A sixth model 202(6) (e.g., Model F) may represent the scheduling platform selecting a representative for task assignment based on a number of accepted tasks prior to a first available time slot. According to the logic in the sixth model 202(6), the scheduling platform may identify the first available time slot associated with each representative. The scheduling platform may then determine a number of accepted tasks prior to the respective first available times. The scheduling platform may compare the number of accepted tasks prior to the first available time associated with each representative and select the representative corresponding to the lowest number of accepted tasks prior to the first available time. In examples in which two or more representatives have a same (lowest) number of accepted tasks prior to the first available time slot, the scheduling platform may select the representative based on random or sequential task routing.

A seventh model 202(7) (e.g., Model G) may represent the scheduling platform selecting a representative for task assignment based on a number of pending and/or accepted system-managed tasks prior to a first available time slot. According to the logic in the seventh model 202(7), the scheduling platform may identify the first available time slot associated with each representative. The scheduling platform may then determine a number of pending and/or accepted system-managed tasks prior to the respective first available times. The scheduling platform may compare the number of pending and/or accepted system-managed tasks prior to the first available time associated with each representative and select the representative corresponding to the lowest number of pending and/or accepted system-managed tasks prior to the first available time. In examples in which two or more representatives have a same (lowest) number of pending and accepted tasks prior to the first available time slot, the scheduling platform may select the representative based on random or sequential task routing.

An eighth model 202(8) (e.g., Model H) may represent the scheduling platform selecting a representative for task assignment based on a number of accepted system-managed tasks prior to a first available time slot. According to the logic in the eight model 202(8), the scheduling platform may identify the first available time slot associated with each representative. The scheduling platform may then determine a number of accepted system-managed tasks prior to the respective first available times. The scheduling platform may compare the number of accepted system-managed tasks prior to the first available time associated with each representative and select the representative corresponding to the lowest number of accepted system-managed tasks prior to the first available time. In examples in which two or more representatives have a same (lowest) number of accepted tasks prior to the first available time slot, the scheduling platform may select the representative based on random or sequential task routing.

Additionally or alternatively, the scheduling platform may be configured to select a representative for task assignment based on a context associated with the task. In various examples, the scheduling platform may determine the context associated with the task. The context may include the characteristic(s) associated with the task, a task type, characteristic(s) associated with the contact, a channel through which the task was requested (e.g., contact requested a meeting via electronic mail, telephone, application, etc.), or the like. In some examples, the model 202 selected for determining the representative may be based at least in part on the context associated with the task. For example, an organization may include a preference to schedule IT service calls utilizing the first model 202(1) and demonstrations utilizing the sixth model 202(6).

In various examples, the scheduling platform may select the representative for task assignment based on one or more characteristics associated with each representative of the organization and/or of the group of representatives. The representative characteristic(s) may include an area of expertise, an education, a performance history (e.g., performance scores associated with task type, overall performance score, high task completion rate, etc.), or the like. In some examples, the representative characteristic(s) may be determined by the organization, such as by monitoring task completion rates utilizing a computing device configured to communicate with the scheduling platform. In some examples, the representative characteristic(s) may be determined based on information provided by a third-party service computing device, such as based on survey results and/or other performance tracking systems or services provided by the third-party service. In various examples, the scheduling platform may determine a context associated with the task and may select and/or bias a selection of a representative based on the representative characteristic(s) associated therewith. In various examples, the bias may be proportional to a number of tasks completed in a time period.

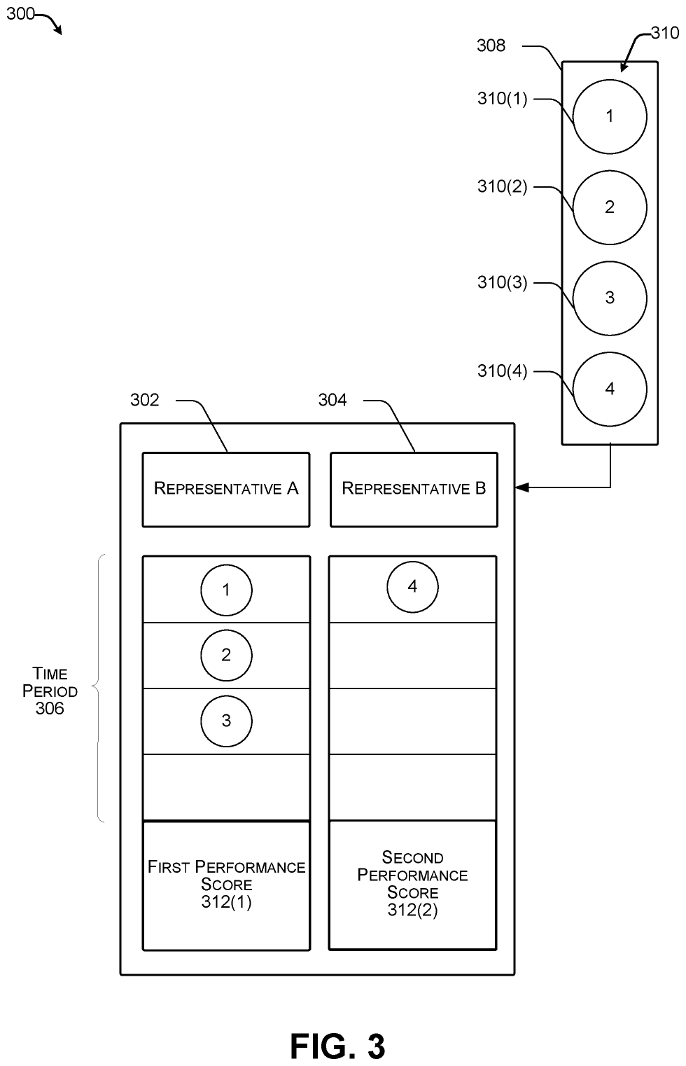

FIG. 3 illustrates a representation 300 of historical performances of two representatives, a first representative 302 (illustrated as representative A) and a second representative 304 (illustrated as representative A), during a time period 306, utilizing the techniques described herein. In the illustrative example, the historical performance may be based on task completion of one or more tasks over the time period 306. In other examples, the historical performance may be based on revenue generated per task assignment, profit generated per task assignment, feedback provided by a contact, and the like.

As illustrated in FIG. 3, the scheduling platform 308 may determine four tasks 310, such as a first task 310(1), a second task 310(2), a third task 310(3), and a fourth task 310(4), that were completed by the first representative 302 and the second representative 304 during a time period. In various examples, the tasks 310 may include a particular (same) task type. In such examples, an evaluation and/or comparison of performance based on task completion may be based on a same task type.

In various examples, the assignment of the tasks 310 may have been based on performance and/or one or more scheduling models, such as scheduling models 202 of FIG. 2. As illustrated in FIG. 3, the scheduling platform 308 determines that the first representative 302 completed the first task 310(1), a second task 310(2), a third task 310(3) during the time period 306 and the second representative 304 completed the fourth task 310(4) during the time period 306. In some examples, the scheduling platform 308 may determine a first performance score associated with the first representative 302 and a second performance score 312(2) associated with the second representative 304, based on the completed tasks 310 during the time period.

In various examples, the first performance score 312(1) and the second performance score 312(2) may be based on additional performance data, such as that described above (e.g., revenue, profit, etc.). In some examples, the first performance score 312(1) and the second performance score 312(2) may include a context bias. For example, based on a determination that the first representative 302 completed three tasks 310 (e.g., the first task 310(1), the second task 310(2), and the third task 310(3)) and the second representative completed a single task 310 (e.g., the fourth task 310(4)), the scheduling platform may apply a context bias of 75% toward the first representative 302.

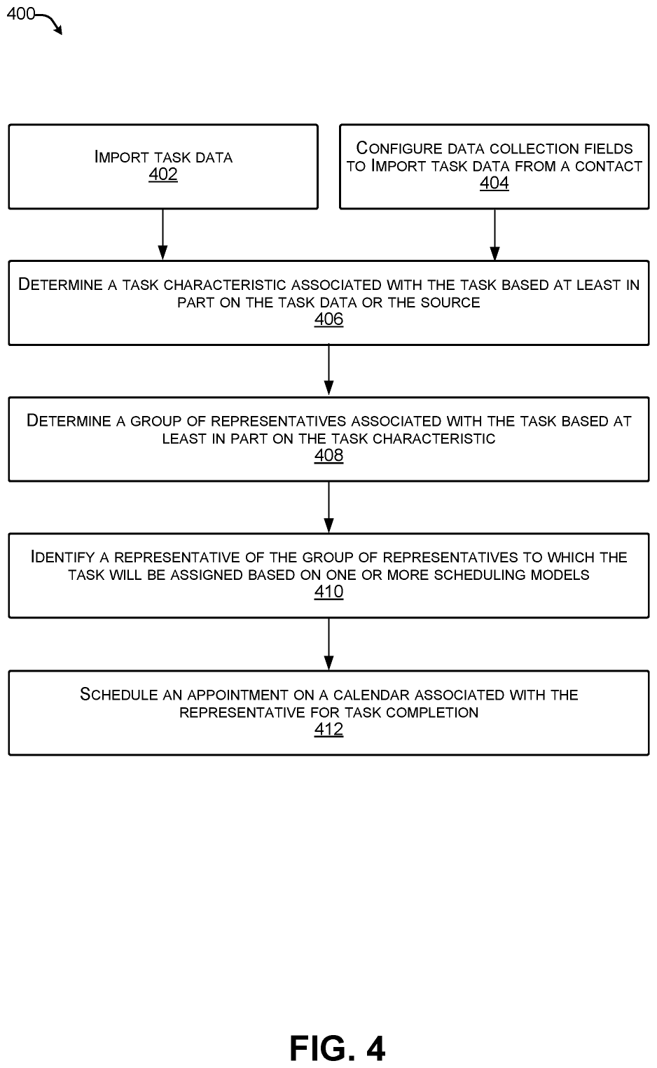

FIGS. 4-12 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

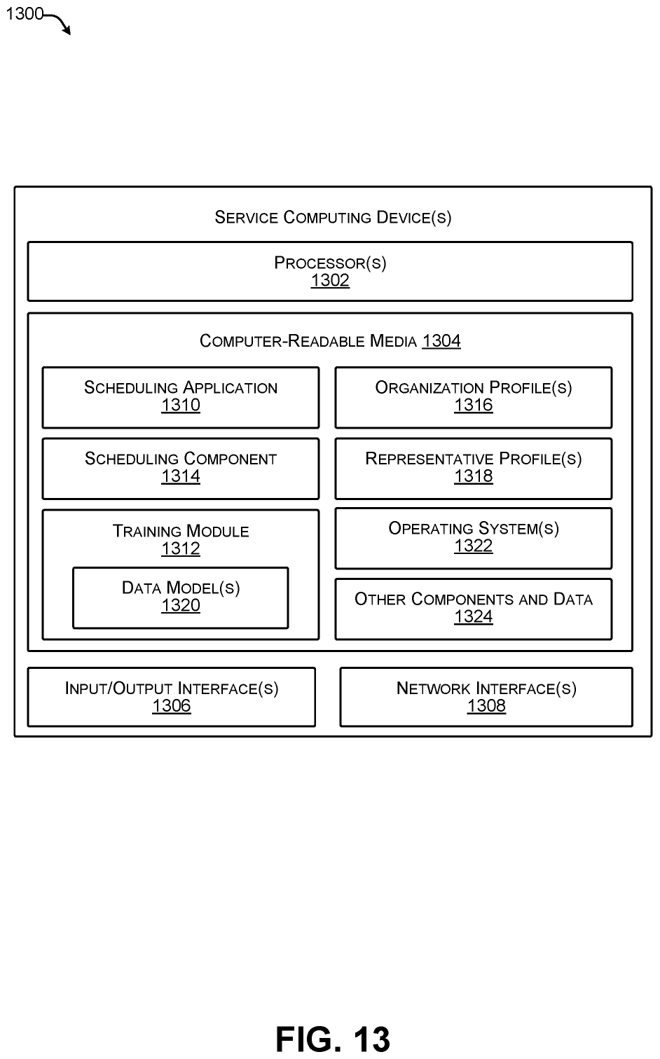

FIG. 4 illustrates an example process 400 for identifying a representative for task assignment, utilizing the techniques described herein. As discussed herein, a scheduling platform may be configured to automatically schedule a meeting (e.g., assign the task at a particular time, during a particular time slot, etc.) between a selected representative and a contact associated with a task. In some instances, some or all of process 400 may be performed by one or more components in the system 100 (e.g., scheduling platform 104, representative computing device 110, and/or contact computing device 112) and/or by the service computing device 1300 of FIG. 13.

At operation 402, the scheduling platform may import task data. The task data may be received from a from a contact computing device associated with a contact. The task data may include a request for a task to be performed by a representative of the organization. For example, the task data may include a request for a demonstration of capabilities of a product provided by the organization. The task data may be transmitted via a communication from the contact (e.g., via email, text message, etc.) and/or may be received via data collection fields associated with an application of the contact computing device (e.g., on a web application accessed via a web browser, native application, etc.). For example, the contact may launch an application associated with the organization on a contact computing device and may submit a support ticket for a hardware platform managed provided by the organization. In various examples, at operation 404, the scheduling platform may be configured to configure data collection fields associated with an application) to import task data from a contact. In such examples, the scheduling platform may request particular task data for efficiently and effectively scheduling an appointment between a representative and the contact. In some examples, a request from the contact may include and/or the data collection fields may be associated with task data describing a problem the contact is experiencing. In some examples, the task data may include an urgency associated with the request (e.g., level of importance, etc.). For example, the task data may include a tier 1 level request for IT support.

In some examples, the task data may be imported from an organizational profile associated with an organization. In such examples, the organizational profile may include one or more task settings including a preference of the organization to have a task associated with one or more contacts of the organization completed at a designated time. In some examples, the task may include a single task to be performed by a representative of the organization. In some examples, the task may include a reoccurring task, such as one to be performed at periodic intervals (e.g., monthly, quarterly, annually, bi-annually, etc.). In some examples, the scheduling platform may determine that a current time is within a threshold time (e.g., 5 days, two weeks, one month, etc.) associated with scheduling a first task of the reoccurring tasks. In such examples, the scheduling platform may identify a representative to perform the task and may determine to schedule the task between a representative and the associated contact. In some examples, the task data may include contact data from a contact computing device associated with a contact, such as via an application associated with the contact computing device. As described above, the contact data may include a request for a task. In some examples, the contact data may include one or more contact characteristics.

At operation 406, the scheduling platform may determine a task characteristic associated with the task based at least in part on the task data. In some examples, the scheduling platform may determine one or more characteristics associated with the task. The task characteristic(s) may include a task type (e.g., type of meeting requested, such as a demonstration, a check-in, enablement meeting, help desk ticket, etc.), a service associated with the task (e.g., update a product, fix a bug in software, stock shelves at a brick and mortar store, etc.), a time associated with the task (e.g., time created, time for completion, etc.), contact data associated therewith (e.g. a position of the contact at the organization associated therewith (e.g., Chief Executive Officer (CEO), Chief Financial Officer (CFO), President, manager, etc.), existing contact, new contact, etc.), a level of importance of the task, or the like.

At operation 408, the scheduling platform may determine a group of representatives associated with the task based at least in part on the task characteristic. In various examples, the group of representatives may be identified based on one or more rules associated with the scheduling platform. The rule(s) may be based on the characteristic of the task, such as a task type, a new contact, an existing contact, contact preferences, representative characteristics (e.g., type of representative, area of expertise, etc.), pre-defined representative teams (e.g., predefined groups of representatives), or the like. In some examples the one or more rules may be defined by the organization, such as in organizational preferences stored in an organization profile. In some examples, the rule(s) may be determined at an initialization stage of the scheduling platform with the organization. In such examples, the organization may set an initial set of preferences. In some examples, the rule(s) may be determined after initialization, such as after operating the scheduling platform for a time and identifying rules to add or remove to the one or more rules. In some examples, the rules may be determined based on one or more machine learned techniques. In such examples, the scheduling platform may include a training component configured to train one or more data models to determine one or more rules to maximize efficiencies associated with generating the group of representatives.

In at least one example, the scheduling platform may determine the group of representatives based on a task type associated with the task. In some examples, the group of representatives may be associated with particular tasks, based on qualifications, employment positions (e.g., sales person, IT support, etc.), experience at an organization, and the like. For example, sales people may be assigned to perform demonstrations of product capabilities to potential and existing customers (e.g., contacts). Based on determining that a task includes a demonstration, the scheduling platform may identify a group of representatives including sales people capable of performing the task.

In various examples, the scheduling platform may determine the group of representatives based on performance of the representatives in an organization. In some examples, the scheduling platform may access historical performance data associated with representatives such as that stored in a representative profile. The historical performance may include statistics associated with completing a task, converting a task to an opportunity (e.g., demonstration to a potential sale), converting an opportunity into a closed sale, average revenue per task performed, average profit per task performed, average cost per task performed, and the like.

In some examples, the scheduling platform may determine a performance score associated with each representative of an organization. In some examples, the performance scores may be stored in the representative profiles and/or the organization profiles. In some examples, the performance scores may be associated with a task type. For example, a first representative may have an associated first performance score associated with a first task and a second performance score associated with a second task. The scheduling platform may determine that the first representative performs better at the first task than the second task based on a determination that the first performance score is greater than the second performance score.

In some examples, the group of representatives may be determined based on performance of a representative relative to an average performance of representatives in an organization. In some examples, the scheduling platform may determine an average performance of representatives across the organization. In some examples, the scheduling platform may compare the performance of each representative to the average performance. In some examples, the scheduling platform may identify the group of representatives as those including a performance equal to or greater than the average performance score. In some examples, the scheduling platform may identify the group of representatives as those including a performance score that is a threshold amount above the average score.

In some examples, the group of representatives may be determined based on performance of a representative as compared to the performance of other representatives in the organization. In some examples, the scheduling platform may determine a performance score associated with each representative in the organization. For example, the scheduling platform may perform an historical analysis to determine a probability of demonstrations that convert to opportunities, a probability that the opportunities will convert to closed sales. The scheduling platform may multiply the probability of the opportunities converting to closed sales by the average amount of revenue earned from a sale to determine an aggregate average revenue per task. In such examples, the scheduling may compare an average revenue per task of a representative to the aggregate average across a group of representatives.

In some examples, the scheduling platform may identify a first group of representatives as those having an associated performance score equal to or greater than a first threshold, a second group of representatives as those having a performance score equal to or less than the first threshold and equal to or greater than a second threshold, and a third group of representatives as those having a performance score equal to or less than the second threshold. In some examples, the group of representatives may be selected based on the identified first, second, or third group. For example, the scheduling platform may determine that task data associated with a first task indicates that the first task is of low urgency and low difficulty. The scheduling platform may determine the third group of representatives for determining a representative for task assignment. For another example, the scheduling platform may determine that task data associated with a second task indicates that the second task is of high urgency and includes a high-profile contact (e.g., CEO of another organization, high revenue client, etc.). Based on a determination that the second task is high urgency and involves a high-profile contact, the scheduling platform may determine the first group (e.g., best performing) of representatives for task assignment.

In some examples, the scheduling platform may determine the group of representatives based on a scheduling availability to perform the task. In some examples, the scheduling availability may be defined by a work schedule. In such examples, the group of representatives may include representatives that are available during particular hours and/or particular days of the week. In some examples, the scheduling availability may be defined based on a general calendar availability over a pre-determined period of time. In such examples, the performance capability may include representatives that don't have calendar days blocked out over the period of time. For example, the scheduling platform may determine that a representative of the organization may start a two-week vacation the following day. Based on the determination of the pending vacation and calendar unavailability, the scheduling platform may not include the representative in the group of representatives.

At operation 410, the scheduling platform may identify a representative of the group of representatives to which the task will be assigned based on one or more scheduling models. In some examples, the scheduling model(s) may be determined based on the characteristic of the task, such as based on a task type. For example, the scheduling platform may utilize a first model to determine a representative based on a determination that a task type associated with the task includes a tier 1 IT support request. In some examples, the scheduling model may be determined based on an organizational preference for scheduling. In some examples, the scheduling model may be determined based on contact data associated with the contact. For example, the scheduling platform may determine to utilize a first model for scheduling tasks associated with a high-profile contact and a second model for scheduling tasks associated with a non-high-profile contact.

At operation 412, the scheduling platform may schedule an appointment on a calendar of the representative for task completion. In some examples, the scheduling platform may send an invitation for the appointment to the associated contact. In some examples, the appointment on the calendar of the representative may include a pending appointment until the scheduling platform receives an acceptance of the invitation from the contact. The pending appointment may or may not be presented to the representative. In various examples, based on receiving an acceptance of the invitation from the contact, the scheduling platform may present the appointment on the calendar for viewing by the representative.

In some examples, the scheduling platform may schedule the meeting for a first available time slot in the calendar associated with the selected representative. In some examples, the scheduling platform may schedule the meeting based on one or more preferences associated with the selected representative (e.g., preference to have (or not have) a number of consecutive meetings, preference to have meetings scheduled in the morning or afternoon, etc.). In some examples, the preference(s) associated with the selected representative may be stored in a representative profile and/or an organizational profile associated with the organization. In such examples, the scheduling platform may access the preferences associated with the selected representative and may identify a time on the calendar associated therewith for scheduling the meeting. In some examples, the scheduling platform may schedule the meeting at a time determined for optimal performance of the selected representative. In such examples, the scheduling platform may be configured to determine, such as based on task completion rates, survey data from a third-party source, or the like, a time period associated with a maximum performance (e.g., maximum efficiency) of the selected representative and may automatically schedule the meeting during in a time slot in the time period associated with the maximum performance.

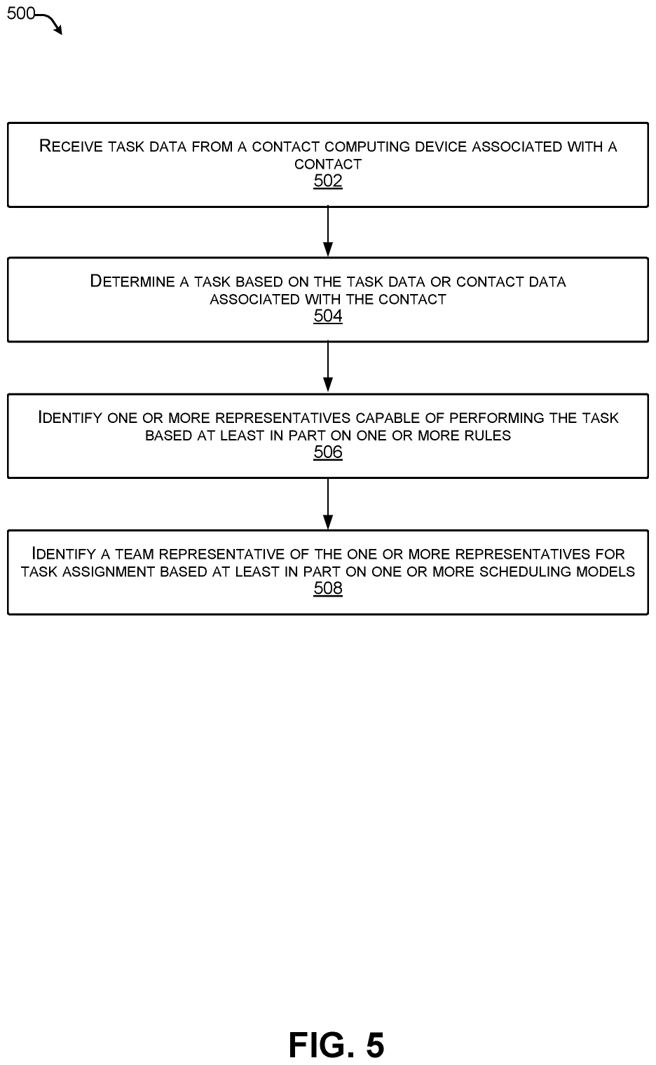

FIG. 5 illustrates an example process 500 for receiving a task from a contact and identifying a representative for task assignment, utilizing the techniques described herein. In some instances, some or all of process 500 may be performed by one or more components in the system 100 (e.g., scheduling platform 104, representative computing device 110, and/or contact computing device 112) and/or by the service computing device 1300 of FIG. 13.

At operation 502, the scheduling platform receives task data from a contact computing device associated with a contact. The task data may include a request for a task to be performed by a representative of the organization. For example, the task data may include a request for a demonstration of capabilities of a product provided by the organization. The task data may be transmitted via a communication from the contact (e.g., via email, text message, etc.) and/or may be received via data collection fields associated with an application of the contact computing device (e.g., on a web application accessed via a web browser, native application, etc.). For example, the contact may launch an application associated with the organization on a contact computing device and may submit a support ticket for a hardware platform managed provided by the organization.

At operation 504, the scheduling platform determines a task based on the task data or contact data associated with the contact. In various examples, the task data may explicitly state the task to be performed. For example, a request for a demonstration related to a particular product may explicitly state the demonstration task type. In some examples, the scheduling platform may implicitly determine the task type based on the request. For example, the task data may include a request for IT support. The scheduling platform may determine that a call between an IT service provider and the contact may be necessary. In such an example, the task may include a phone call to address the IT support request.

At operation 506, the scheduling platform identifies one or more representatives capable of performing the task based at least in part on one or more rules. The rule(s) may be based on the characteristic of the task, such as a task type, a new contact, an existing contact, contact preferences, representative characteristics (e.g., type of representative, area of expertise, etc.), pre-defined representative teams (e.g., predefined groups of representatives), or the like. In some examples the one or more rules may be defined by the organization, such as in organizational preferences stored in an organization profile. In some examples, the rule(s) may be determined at an initialization stage of the scheduling platform with the organization. In such examples, the organization may set an initial set of preferences. In some examples, the rule(s) may be determined after initialization, such as after operating the scheduling platform for a time and identifying rules to add or remove to the one or more rules. In some examples, the rules may be determined based on one or more machine learned techniques. In such examples, the scheduling platform may include a training component configured to train one or more data models to determine one or more rules to maximize efficiencies associated with generating the group of representatives.

At operation 508, the scheduling platform identifies a representative of the one or more representatives for task assignment based at least in part on one or more scheduling models. In some examples, the scheduling model(s) may be determined based on the characteristic of the task, such as based on a task type. For example, the scheduling platform may utilize a first model to determine a representative based on a determination that a task type associated with the task includes a tier 1 IT support request. In some examples, the scheduling model may be determined based on an organizational preference for scheduling. In some examples, the scheduling model may be determined based on contact data associated with the contact. For example, the scheduling platform may determine to utilize a first model for scheduling tasks associated with a high-profile contact and a second model for scheduling tasks associated with a non-high-profile contact.

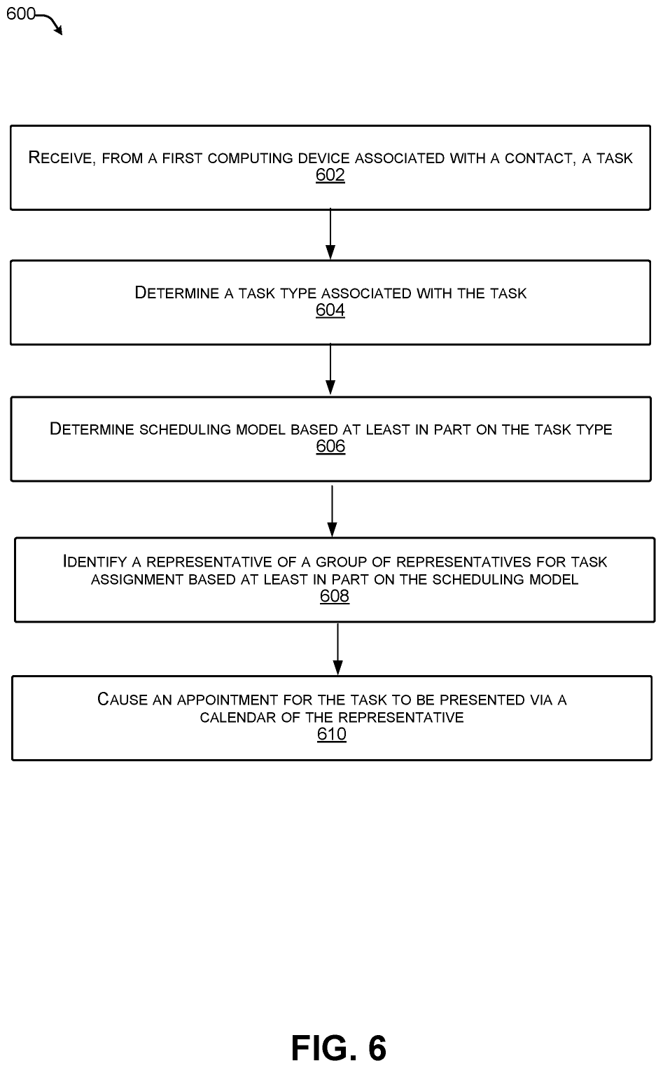

FIG. 6 illustrates an example process 600 for scheduling an appointment for a task to be completed based on a task type associated therewith, utilizing the techniques described herein. In some instances, some or all of process 600 may be performed by one or more components in the system 100 (e.g., scheduling platform 104, representative computing device 110, and/or contact computing device 112) and/or by the service computing device 1300 of FIG. 13.

At operation 602, the scheduling platform receives, from a first computing device associated with a contact, a task. The task may include a request to conduct a meeting or perform a service for the contact. As discussed above, the scheduling platform may receive task data and may determine the task based on the task data.

At operation 604, the scheduling platform determines a task type associated with the task. The task type may include a type of meeting requested, such as a demonstration, a check-in, enablement meeting, help desk ticket, or the like.

At operation 606, the scheduling platform determines a scheduling model based at least in part on the task type. The scheduling model may include any one of the scheduling models 202 of FIG. 2. In some examples, the scheduling model may be determined based at least in part on organizational preferences associated with the task types. In such examples, the scheduling platform may access the organizational preferences, such as those stored in an organizational profile, to determine the scheduling model.

At operation 608, the scheduling platform identifies a representative of a group of representatives for task assignment based at least in part on the scheduling model. The group of representatives may include representatives of an organization that are associated with the task type. In some examples, the group of representatives may include representative that have availability on respective calendars (e.g., not on vacation, on sick leave, etc.). In some examples, the group of representatives may include representatives that have an associated performance score equal to or greater than a threshold score.

At operation 610, the scheduling platform causes an appointment for the task to be presented via a calendar of the representative. In some examples, the scheduling platform may send an invitation for the appointment to the associated contact. In some examples, the appointment on the calendar of the representative may include a pending appointment until the scheduling platform receives an acceptance of the invitation from the contact. The pending appointment may or may not be presented to the representative. In various examples, based on receiving an acceptance of the invitation from the contact, the scheduling platform may present the appointment on the calendar for viewing by the representative.

In some examples, the scheduling platform may schedule the meeting for a first available time slot in the calendar associated with the selected representative. In some examples, the scheduling platform may schedule the meeting based on one or more preferences associated with the selected representative (e.g., preference to have (or not have) a number of consecutive meetings, preference to have meetings scheduled in the morning or afternoon, etc.). In some examples, the preference(s) associated with the selected representative may be stored in a representative profile and/or an organizational profile associated with the organization. In such examples, the scheduling platform may access the preferences associated with the selected representative and may identify a time on the calendar associated therewith for scheduling the meeting. In some examples, the scheduling platform may schedule the meeting at a time determined for optimal performance of the selected representative. In such examples, the scheduling platform may be configured to determine, such as based on task completion rates, survey data from a third-party source, or the like, a time period associated with a maximum performance (e.g., maximum efficiency) of the selected representative and may automatically schedule the meeting during in a time slot in the time period associated with the maximum performance.

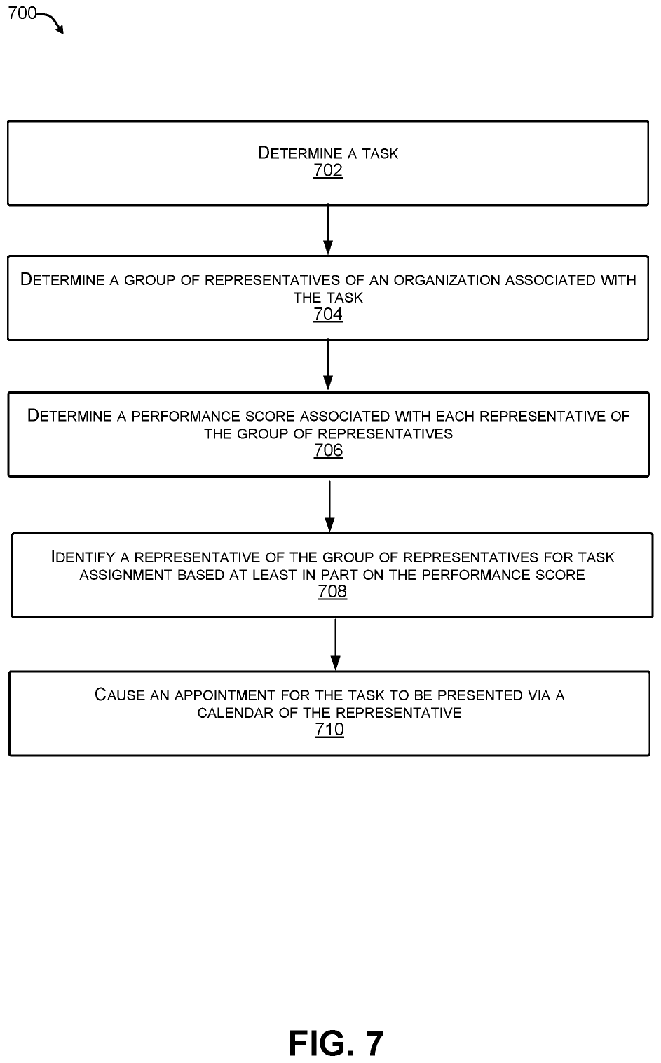

FIG. 7 illustrates an example process 700 for identifying a representative to complete a task based on a performance score associated therewith, utilizing the techniques described herein. In some instances, some or all of process 700 may be performed by one or more components in the system 100 (e.g., scheduling platform 104, representative computing device 110, and/or contact computing device 112) and/or by the service computing device 1300 of FIG. 13.

At operation 702, the scheduling platform determines a task. In some examples, the task may be determined based on task data received from a contact computing device associated with a contact, as discussed above. In some examples, the task may be determined based on organizational preferences associated with an organization. In such examples, the organizational preferences may include task settings including a preference of the organization to have a task associated with one or more contacts of the organization completed at a designated time. In some examples, the task may include a single task to be performed by a representative of the organization. In some examples, the task may include a task to be performed by a representative during a work day. In some examples, the task may include a meeting with another person or a task to be performed by the representative alone (e.g., stocking shelves, inventory evaluation, expense report, etc.). In some examples, the task may be dynamically determined, based on real-time or near real-time input from a computing device of an organization. For example, a manager may input, via an organizational computing device, a request for a task to be performed by a representative of a particular department of which the manager is associated.

In some examples, the task may include a reoccurring task, such as one to be performed at periodic intervals (e.g., monthly, quarterly, annually, bi-annually, etc.). In some examples, the scheduling platform may determine that a current time is within a threshold time (e.g., 5 days, two weeks, one month, etc.) associated with scheduling a first task of the reoccurring tasks. In such examples, the scheduling platform may identify a representative to perform the task and may determine to schedule the task between a representative and the associated contact.

At operation 704, the scheduling platform determines a group of representatives of an organization associated with the task. In various examples, the group of representatives may be identified based on one or more rules associated with the scheduling platform. In some examples, the scheduling platform may determine the group of representatives based on a task type associated with the task. In some examples, the group of representatives may be associated with particular tasks, based on qualifications, employment positions (e.g., sales person, IT support, etc.), experience at an organization, and the like.

In various examples, the scheduling platform may determine the group of representatives based on performance of the representatives in the organization. In some examples, the scheduling platform may access historical performance data associated with representatives such as that stored in a representative profile. The historical performance may include statistics associated with completing a task, converting a task to an opportunity (e.g., demonstration to a potential sale), converting an opportunity into a closed sale, average revenue per task performed, average profit per task performed, average cost per task performed, and the like.

In some examples, the scheduling platform may determine a performance score associated with each representative of an organization. In some examples, the performance scores may be stored in the representative profiles and/or the organization profiles. In some examples, the performance scores may be associated with a task type. For example, a first representative may have an associated first performance score associated with a first task and a second performance score associated with a second task. The scheduling platform may determine that the first representative performs better at the first task than the second task based on a determination that the first performance score is greater than the second performance score.

In some examples, the scheduling platform may determine the group of representatives based on performance of a representative relative to an average performance of representatives in an organization. In some examples, the scheduling platform may determine an average performance of representatives across the organization. In some examples, the average performance may be based on an aggregate revenue per task calculation, as discussed above. In some examples, the scheduling platform may compare the performance of each representative to the average performance. In some examples, the scheduling platform may identify the group of representatives as those including a performance equal to or greater than the average performance score. In some examples, the scheduling platform may identify the group of representatives as those including a performance score that is a threshold amount above the average score.

In some examples, the scheduling platform may identify a first group of representatives as those having an associated performance score equal to or greater than a first threshold, a second group of representatives as those having a performance score equal to or less than the first threshold and equal to or greater than a second threshold, and a third group of representatives as those having a performance score equal to or less than the second threshold. In some examples, the group of representatives may be selected based on the identified first, second, or third group. For example, the scheduling component of the scheduling platform may determine that task data associated with a first task indicates that the first task is of low urgency. The scheduling component may determine the third group of representatives for determining a representative for task assignment. For another example, the scheduling component of the scheduling platform may determine that task data associated with a second task indicates that the second task is of high urgency and includes a high-profile contact (e.g., CEO of another organization, high revenue client, etc.). Based on a determination that the second task is high urgency and involves a high-profile contact, the scheduling component may determine the first group (e.g., best performing) of representatives for task assignment.

In some examples, the scheduling platform may determine the group of representatives based on a scheduling availability to perform the task. In some examples, the scheduling availability may be defined by a work schedule. In such examples, the group of representatives may include representatives that are available during particular hours and/or particular days of the week. In some examples, the scheduling availability may be defined based on a general calendar availability over a pre-determined period of time. In such examples, the performance capability may include representatives that don't have calendar days blocked out over the period of time. For example, the scheduling component scheduling platform may determine that a representative of the organization may start a two-week vacation the following day. Based on the determination of the pending vacation and calendar unavailability, the scheduling component scheduling platform may not include the representative in the group of representatives.

At operation 706, the scheduling platform determines a performance score associated with each representative of the group of representatives. The performance score may include individual scores associated with each representative of the group of representatives. As discussed above, the performance score may be based on a task type.

At operation 708, the scheduling platform identifies a representative of the group of representatives for task assignment based at least in part on the performance score. In some examples, the scheduling platform may identify a representative with a score equal to or greater than a threshold score (e.g., high performing) representative of the group of representatives. In some examples, the scheduling platform may identify a representative with a score below a threshold score (e.g., low performing) representative of the group of representatives, such as to give the representative additional experience and/or to assist in raising the score. In some examples, the scheduling platform may identify a representative within a threshold above or below a mean performance score.

At operation 710, the scheduling platform causes an appointment for the task to be presented on a calendar of the representative. The calendar may be presented on a user interface associated with a representative account, such as that visible via a first instance of a scheduling application. In examples of tasks involving two parties (e.g., meeting between a representative and a contact), the scheduling platform may schedule an appointment on a calendar of the representative for task completion and send an invitation for the appointment to the associated contact. In some examples, the appointment on the calendar of the representative may include a pending appointment until the scheduling platform receives an acceptance of the invitation from the contact. The pending appointment may or may not be presented to the representative. In various examples, based on receiving an acceptance of the invitation from the contact, the scheduling platform may cause the appointment to be presented on the calendar for viewing by the representative.

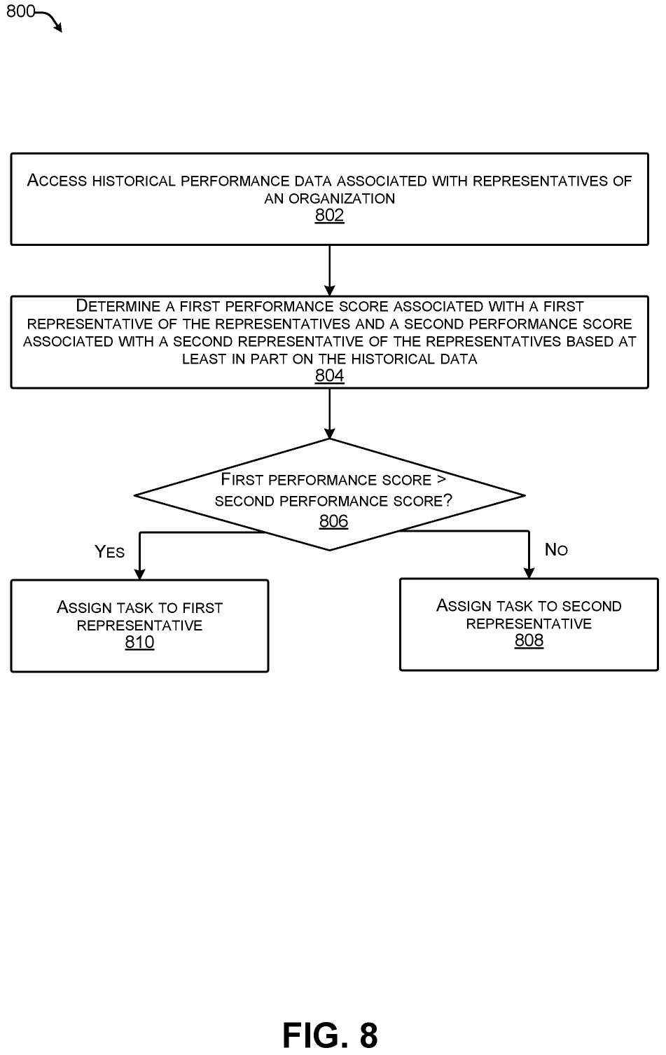

FIG. 8 illustrates an example process 800 for assigning a task to a representative based on a performance score associated therewith, utilizing the techniques described herein. In some instances, some or all of process 800 may be performed by one or more components in the system 100 (e.g., scheduling platform 104, representative computing device 110, and/or contact computing device 112) and/or by the service computing device 1300 of FIG. 13.

At operation 802, the scheduling platform accesses historical performance data associated with representatives of an organization. The historical performance data may include statistics associated with completing a task, converting a task to an opportunity (e.g., demonstration to a potential sale), converting an opportunity into a closed sale, average revenue per task performed, average profit per task performed, average cost per task performed, and the like. The historical performance data may be stored on a datastore of the scheduling platform in an organizational profile and/or representative profiles associated with the representatives.

At operation 804, the scheduling platform determines a first performance score associated with a first representative of the representatives and a second performance score associated with a second representative of the representatives.

At operation 806, the scheduling platform determines whether the first performance score is greater than the second performance score.

Based on a determination that the first performance score is greater than the second performance score (“Yes” at operation 806), the scheduling platform, at operation 808, assigns the task to the first representative.

Based on a determination that the first performance score is greater than the second performance score (“No” at operation 806), the scheduling platform, at operation 810, assigns the task to the second representative.

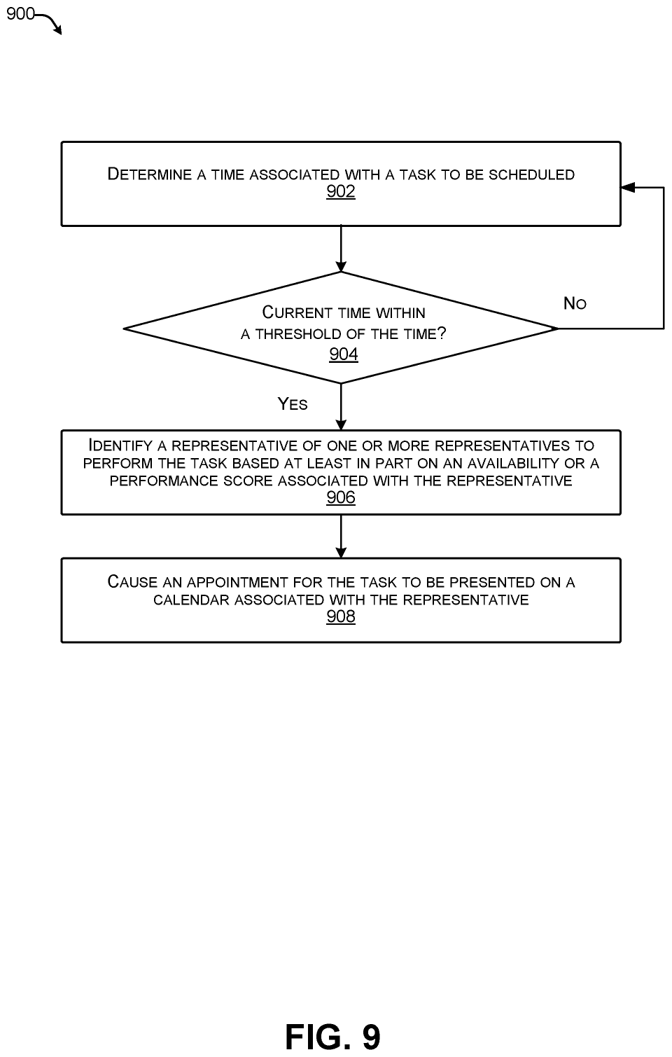

FIG. 9 illustrates an example process 900 for determining a task to be assigned to a representative, utilizing the techniques described herein. In some instances, some or all of process 900 may be performed by one or more components in the system 100 (e.g., scheduling platform 104, representative computing device 110, and/or contact computing device 112) and/or by the service computing device 1300 of FIG. 13.

At operation 902, the scheduling platform determines a time associated with a task to be scheduled. In some examples, the time may be determined based on task data. In some examples, the task data may include a level of urgency. In such examples, the level of urgency may determine the time associated with the task. For examples, tasks with a first level of urgency should be performed within 4 hours and tasks with a second level of urgency should be performed within one week. In various examples, the task may be received from a contact. In such examples, the contact may provide a time associated with the task. For example, a request for demonstration from a contact may include a note requesting the demonstration within the next week.

In some examples, the tasks may be determined based on organizational preferences. In such examples, the organizational preferences may include task settings, such as periodic intervals at which tasks should be performed. For example, the organizational preferences may include quarterly check-in meetings with customers. The scheduling platform may determine the time associated with the check-in meetings includes the three months within the quarter. In some examples, the scheduling platform may determine a time associated with a previous meeting with a particular customer. In some examples, the scheduling platform may determine that the time associated with the task is at least a period of time (e.g., two months, three months, etc.) from the previous meeting. For example, continuing the example from above, the scheduling platform may determine that the organization prefers for sales people to perform quarterly check-in meetings with customers. The scheduling platform may determine that a previous check-in meeting with a particular customer was at the end of a first quarter (e.g., March 15). To avoid conducting back-to-back meetings, the scheduling platform may determine a time associated with a next meeting (the task) to be at least the period of time after the previous check-in meeting. Accordingly, the scheduling platform may determine the time to be a time between May 15 and June 30.

In some examples, the tasks may be dynamically determined based on real-time or near-real-time input from a computing device associated with the organization. In such examples, the input may include a task to be performed and a time frame (e.g., time period, time at which it should be complete, etc.) associated therewith. For example, a floor manager of a grocery store may submit a task for the shelves on aisles 1-5 to be reviewed and/or restocked before 5 pm. The scheduling application may receive the task and determine the time associated therewith is 5 pm.

At operation 904, the scheduling platform may determine whether a current time is within a threshold of the time. In some examples, the threshold is determined based on an organizational preference (e.g., to schedule tasks a minimum number of days in the future (e.g., schedule tasks at least two days from the current time), to not schedule tasks more than a maximum number of days in the future, etc.). In some examples, the threshold may be determined based on a scheduling platform setting. In such examples, the scheduling platform may determine the threshold based on a manually input setting (e.g., by a programmer), a setting determined by one or more data models of a machine learning system, a setting determined based on heuristics, observation, experimentation, or the like.

Based on a determination that the current time is not within the threshold of the time (“No” at operation 904), the scheduling platform determines the time associated with the task to be scheduled, as described at operation 902. In some examples, the scheduling platform may continually determine the current time and whether the current time is within the threshold in a loop until determining that the current time is within the threshold of the time.

Based on a determination that the current time is not within the threshold of the time (“No” at operation 904), the scheduling platform, at operation 906, identifies a representative of one or more representatives to perform the task based at least in part on an availability or a performance score associated with the representative. In some examples, the representative may be determined utilizing one or more scheduling models, as discussed above. In such examples, the scheduling models may be determined based on an organizational preference, a task type, and/or a default setting associated with the scheduling platform.

At operation 908, the scheduling platform may cause an appointment for the task to be presented on a calendar associated with the representative. The calendar may be presented on a display of a representative computing device associated with the representative. In some examples, the calendar may be presented via a user interface associated with an instance of a scheduling application. In some examples, the scheduling platform may send an invitation for the appointment to the associated contact. In some examples, the appointment on the calendar of the representative may include a pending appointment until the scheduling platform receives an acceptance of the invitation from the contact. The pending appointment may or may not be presented to the representative. In various examples, based on receiving an acceptance of the invitation from the contact, the scheduling platform may present the appointment on the calendar for viewing by the representative.

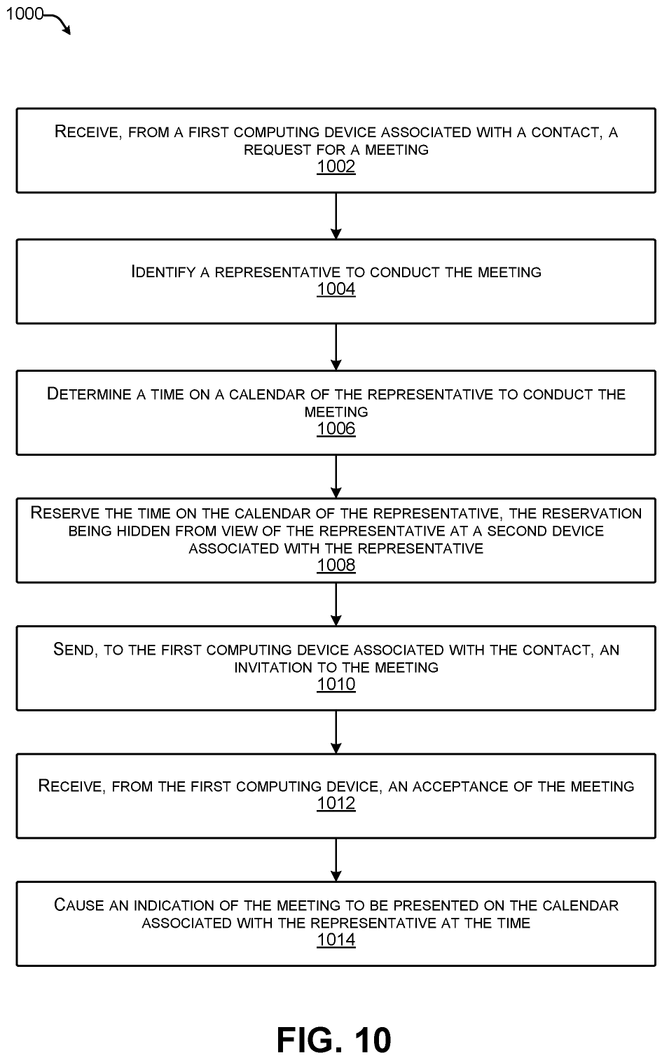

FIG. 10 illustrates an example process 1000 for automatically scheduling a meeting on a calendar of a representative, utilizing the techniques described herein. In some instances, some or all of process 1000 may be performed by one or more components in the system 100 (e.g., scheduling platform 104, representative computing device 110, and/or contact computing device 112) and/or by the service computing device 1300 of FIG. 13.

At operation 1002, the scheduling platform may receive, from a first computing device associated with a contact, a request for a meeting (e.g., a task). The meeting may include a task, such as that described above. In some examples, the request may include task data associated with the meeting, such as a reason for the meeting, a meeting type (e.g., task type), a time period associated with the meeting (e.g., meeting within the next week, next month, etc.), and the like.

At operation 1004, the scheduling platform may identify a representative to conduct the meeting. In some examples, the representative may be determined based on a type of meeting associated therewith. In some examples, the representative may be determined based on a performance score associated therewith. For example, the representative with a first (high) score associated with a particular task type associated with the task may receive the meeting assignment. For another example, the representative with a second (low) score associated with a particular meeting type may receive the task assignment, such as to improve the performance score of the representative through experience. In some examples, the performance-based meeting assignment may be determined based on one or more organizational preferences.

In various examples, the scheduling platform may identify the representative to conduct the meeting based on one or more scheduling models (illustrated in FIG. 2). In various examples, the scheduling model(s) may be based on a number of system generated and/or non-system generated meetings. In some examples, the scheduling model(s) may be based on a number of pending and/or accepted meetings. In various examples, the scheduling model(s) may be determined based on the organizational preferences associated with the organization. In such examples, the scheduling model(s) may be defined during the initialization stage and/or updated at a later time. The scheduling model(s) may represent routing logic utilized by the scheduling platform to determine the representative to which the task will be assigned.

At operation 1006, the scheduling platform determines a time on a calendar of the representative to conduct the meeting. The time may include a time on the calendar that does not have associated therewith a previously scheduled appointment. In some examples, the time may be determined based on one or more organizational and/or representative characteristics associated with scheduling. Organizational characteristics associated with scheduling may include, but are not limited to, maximum number of tasks scheduled in a row for a representative, designated break times between scheduled tasks, maximum number of tasks to be assigned in a day, and the like. Representative characteristics may include a start time for a first task to be scheduled, an end time for a last task of the day to be started and/or finished (e.g., last task to start no later than 4 pm, last task to end no later than 4 pm, etc.), times for one or more breaks (e.g., lunch, coffee, smoke, etc.), maximum and/or minimum times to be scheduled for tasks (e.g., for each tasks based on task type, for all tasks, etc.), other task scheduling preferences (e.g., maximum two tasks scheduled in a row for a representative, 15-minute break between scheduled tasks, maximum 5 tasks to be completed in a day, etc.), and the like.

At operation 1008, the scheduling platform reserves the time on a calendar of the representative to conduct the meeting. In some examples, the reserved time may include a pending appointment. In some examples, the pending appointment may be presented to the representative via the calendar (e.g., at the representative computing device via an instance of the scheduling application). In some examples, the pending appointment may not be presented to the representative via the calendar. In such examples, the pending appointment may be stored in a backend of the scheduling platform and/or the instance of the scheduling application.

At operation 1010, the scheduling platform sends, to the first computing device associated with the contact, an invitation to the meeting at the time. The invitation may be sent via an instance of the scheduling application, an electronic mail message, a text message, via a user account on a website associated with an organization, social networking message, or the like.

At operation 1012, the scheduling platform receives, from the first computing device associated with the contact, an indication of acceptance of the meeting. The indication of acceptance may be received via a same communication means as the invitation was sent or a different means of communication. In some examples, the invitation may include a link to accept the invitation. In such examples, the indication of acceptance may include an indication of selection, by the contact, of the link to accept the invitation.

At operation 1014, the scheduling platform causes an indication of the meeting to be presented on the calendar associated with the representative at the time. The calendar may be presented on a display of a representative computing device associated with the representative. In some examples, the calendar may be presented via a user interface associated with an instance of a scheduling application.

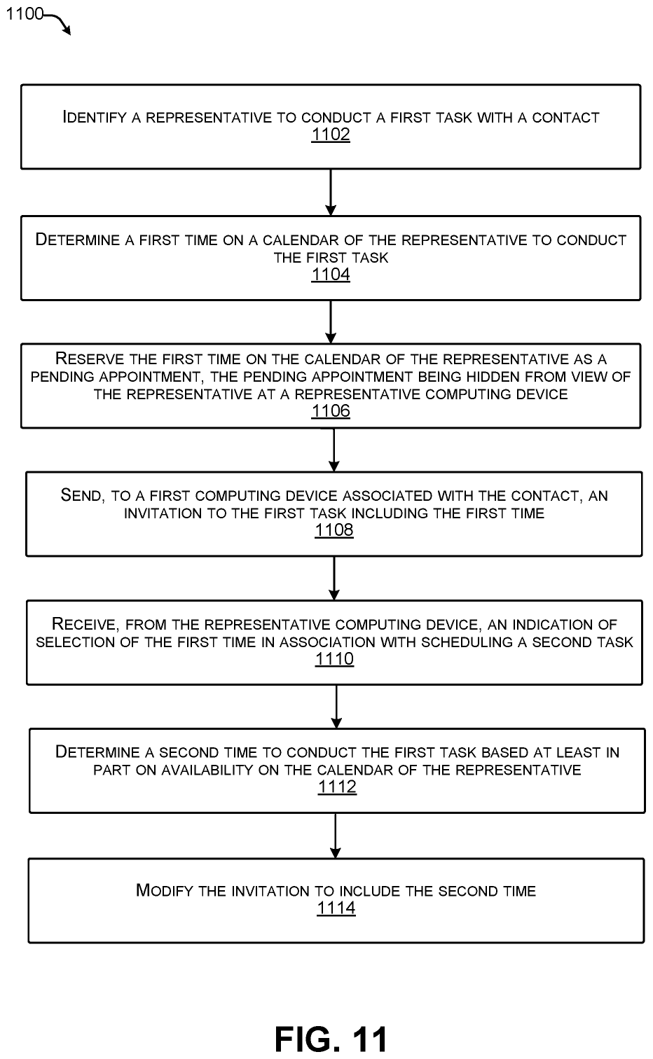

FIG. 11 illustrates an example process 1100 for modifying a meeting time associated with a tentatively scheduled meeting based on input from a representative, utilizing the techniques described herein. In some instances, some or all of process 1100 may be performed by one or more components in the system 100 (e.g., scheduling platform 104, representative computing device 110, and/or contact computing device 112) and/or by the service computing device 1300 of FIG. 13.

At operation 1102, the scheduling platform may identify a representative to conduct a first task (e.g., meeting). In some examples, the representative may be determined based on a type of task associated therewith. In some examples, the representative may be determined based on a performance score associated therewith. In some examples, the representative may be determined based on one or more organizational preferences.

In various examples, the scheduling platform may identify the representative to conduct the meeting based on one or more scheduling models (illustrated in FIG. 2). In various examples, the scheduling model(s) may be based on a number of system generated and/or non-system generated meetings. In some examples, the scheduling model(s) may be based on a number of pending and/or accepted meetings. In various examples, the scheduling model(s) may be determined based on the organizational preferences associated with the organization. In such examples, the scheduling model(s) may be defined during the initialization stage and/or updated at a later time. The scheduling model(s) may represent routing logic utilized by the scheduling platform to determine the representative to which the task will be assigned.

At operation 1104, the scheduling platform determines a first time on a calendar of the representative to conduct the first task. The first time may include a time on the calendar that does not have associated therewith a previously scheduled appointment. In some examples, the first time may be determined based on one or more organizational and/or representative characteristics associated with scheduling. Organizational characteristics associated with scheduling may include, but are not limited to, maximum number of tasks scheduled in a row for a representative, designated break times between scheduled tasks, maximum number of tasks to be assigned in a day, and the like. Representative characteristics may include a start time for a first task to be scheduled, an end time for a last task of the day to be started and/or finished (e.g., last task to start no later than 4 pm, last task to end no later than 4 pm, etc.), times for one or more breaks (e.g., lunch, coffee, smoke, etc.), maximum and/or minimum times to be scheduled for tasks (e.g., for each tasks based on task type, for all tasks, etc.), other task scheduling preferences (e.g., maximum two tasks scheduled in a row for a representative, 15-minute break between scheduled tasks, maximum 5 tasks to be completed in a day, etc.), and the like.

At operation 1106, the scheduling platform reserves the first time on the calendar of the representative as a pending appointment, the pending appointment being hidden from view of the representative at a representative computing device. In some examples, the pending appointment may be stored in a backend of the scheduling platform and/or an instance of the scheduling application on the representative computing device.

At operation 1108, the scheduling platform sends, to a contact computing device associated with the contact, an invitation to the first task including the first time. The invitation may be sent via an instance of the scheduling application, an electronic mail message, a text message, via a user account on a website associated with an organization, social networking message, or the like.

At operation 1110, the scheduling platform receives, from the representative computing device, an indication of selection of the first time in association with scheduling a second task. The second task may include a representative-scheduled task.

At operation 1112, the scheduling platform determines a second time to conduct the first task based at least in part on availability on the calendar of the representative. In some examples, the second time may be determined based on representative and/or organizational preferences associated with scheduling, such as those described above.

At operation 1114, the scheduling platform modifies the invitation to include the second time. In some examples, the modification may include a change to the time associated with the invitation. In some examples, the modification may include a notification of a new time. For example, the invitation may be modified to read “PLEASE NOTE THE UPDATED TIME.”

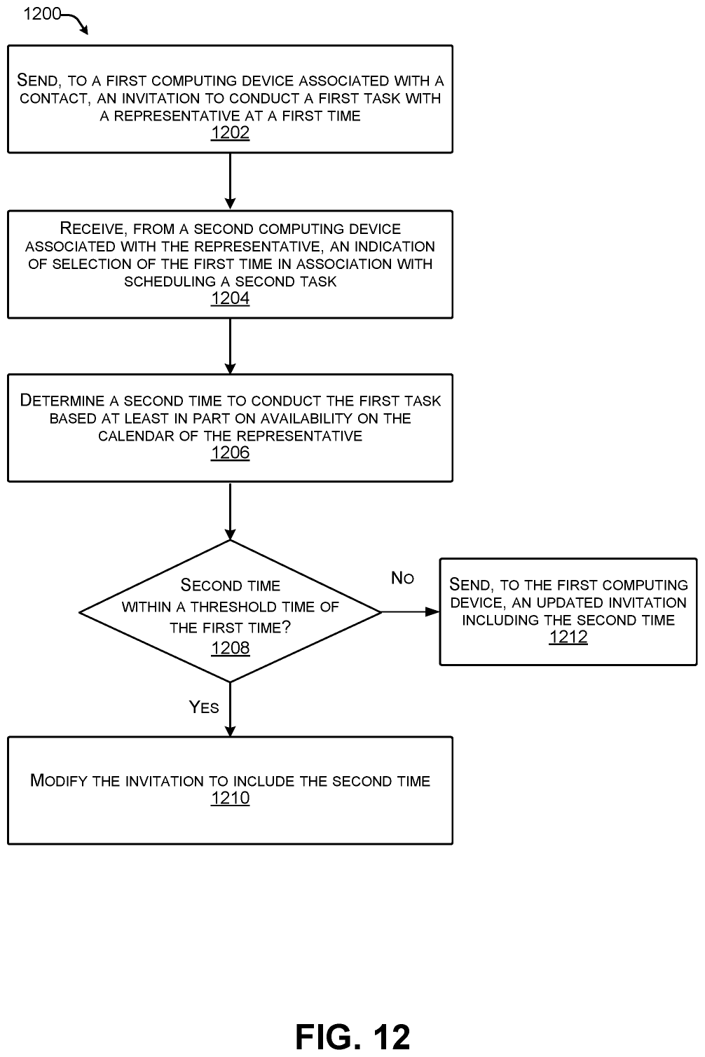

FIG. 12 illustrates a process 1200 for determining whether to modify an invitation associated with a task. In some instances, some or all of process 1200 may be performed by one or more components in the system 100 (e.g., scheduling platform 104, representative computing device 110, and/or contact computing device 112) and/or by the service computing device 1300 of FIG. 13.

At operation 1202, the scheduling platform sends, to a first computing device associated with a contact, an invitation to a first task with a representative at a first time. The invitation may be sent via an instance of the scheduling application, an electronic mail message, a text message, via a user account on a website associated with an organization, social networking message, or the like.

At operation 1204, the scheduling platform receives, from a second computing device, an indication of selection of the first time in association with scheduling a second task. The second task may include a representative-scheduled task.

At operation 1206, the scheduling platform determines a second time to conduct the first task based at least in part on availability on the calendar of the representative. In some examples, the second time may be determined based on representative and/or organizational preferences associated with scheduling, such as those described above.

At operation 1208, the scheduling platform determines whether the second time is within a threshold time of the first time. The threshold time may include a threshold time defined by the scheduling platform based on feedback, observations, experimentation, and the like. In some examples, the threshold time may be based on an organizational preference and/or a representative preference, such as those stored in profiles associated therewith. For example, an organization may input an organizational preference to send a new invitation when a meeting time is modified by more than 1 hour from an originally scheduled meeting time.

Based on a determination that the second time is within the threshold time (“Yes” at operation 1208), the scheduling platform, at operation 1210, modifies the invitation to include the second time. In some examples, the modification may include a change to the time associated with the invitation. In some examples, the modification may include a notification of a new time. For example, the invitation may be modified to read “PLEASE NOTE THE UPDATED TIME.”

Based on a determination that the second time is not within the threshold time (“No” at operation 1208, the scheduling platform, at operation 1212, sends, to the first computing device, an updated invitation including the second time. In some examples, the scheduling platform may delete the original invitation, such as by removing it from an electronic mail inbox associated with the contact.

FIG. 13 is a block diagram illustrating an example system of a service computing device, such as the service computing devices associated with the scheduling platform 104, usable to implement example techniques described herein. The service computing device(s) can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

The service computing device 1300 may be any suitable type of computing device, e.g., mobile, semi-mobile, semi-stationary, or stationary. The service computing device 1300 may belong to a variety of categories or classes of devices such as traditional server-type devices, desktop computer-type devices, mobile devices, special purpose-type devices, embedded-type devices, and/or wearable-type devices. Thus, service computing device 1300 may include a diverse variety of device types and are not limited to a particular type of device. For example, the service-computing device 1300 may represent, but is not limited to, desktop computers, server computers or blade servers such as web-servers, map-reduce servers, or other computation engines or network-attached storage units, personal computers, mobile computers, laptop computers, tablet computers, telecommunication devices, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device capable of sending communications and performing the functions according to the techniques described herein.

In the illustrated example, the service computing device 1300 includes at least one processor 1302, at least one memory 1304, one or more input/output (I/O) interfaces 1306, one or more network interfaces 1308. Each processor 1302 can itself comprise one or more processors or processing cores. For example, the processor 1302 may be implemented as one or more microprocessors, microcomputers, microcontrollers, digital signal processors, central processing units, state machines, logic circuitries, and/or any devices that manipulate signals based on operational instructions. In some cases, the processor 1302 may be one or more hardware processors and/or logic circuits of any suitable type specifically programmed or configured to execute the algorithms and processes described herein. The processor 1302 may be configured to fetch and execute computer-readable processor-executable instructions stored in the memory 1304.

Depending on the configuration of the service computing device 1300, the memory 1304 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 1304 may include, but is not limited to, RAM, ROM, EEPROM, flash memory, solid-state storage, magnetic disk storage, optical storage, and/or other computer-readable media technology. Further, in some cases, the service computing device 1300 may access external storage, such as RAID storage systems, storage arrays, network attached storage, storage area networks, cloud storage, or any other medium that may be used to store information and that may be accessed by the processor 1302 directly or through another computing device or network. Accordingly, the memory 1304 may be computer storage media able to store instructions, modules or components that may be executed by the processor 1302. Further, when mentioned, non-transitory computer-readable media exclude media such as energy, carrier signals, electromagnetic waves, and signals per se.

The memory 1304 may be used to store and maintain any number of functional components that are executable by the processor 1302. In some implementations, these functional components comprise instructions or programs that are executable by the processor 1302 and that, when executed, implement operational logic for performing the actions and services attributed above to the service computing device 1300. Functional components of the service computing device 1300 stored in the memory 1304 may include a scheduling application 1310, such as scheduling application 102, a training module 1312, such as training component 132, and a scheduling component module 1314, such as scheduling component 128. Additionally, functional components of the service computing device 1300 stored on the memory 1304 may include one or more organization profiles 1316, and/or one or more representative profiles 1318.

As discussed above, the service computing device 1300 may include a scheduling application 1310 for scheduling one or more tasks with representatives. In some examples, the service computing device 1300 may manage an instance of the scheduling application 1310 on a representative computing device. In some examples, the service computing device may include an application programming interface between the scheduling application 1310 and an instance of a scheduling application on the representative computing device.

In various examples, the scheduling component 1314 may determine a task, such as that received from a contact, received from a computing device associated with an organization, or determined based on an organizational preference stored in an organizational profile 1316. In various examples, the scheduling component 1314 may determine a group of representatives associated with the task. The group of representatives may include representatives of an organization capable (e.g., qualified, configured to, etc.) perform the task. In some examples, the group of representatives may be determined based on task data, such as based on a task type, or other characteristic associated therewith. In some examples, the group of representatives may be determined based on performance scores associated with representatives associated therewith.

In various examples, the scheduling component 1314 may identify a representative of the group of representatives for task assignment. The scheduling component 1314 may determine the representative based on one or more scheduling models, one or more rules, and/or a performance score associated therewith. In some examples, the representative may be identified based on organizational preferences associated with the organization. The scheduling component 1314 may determine a time on a calendar associated with the representative and may schedule the task to be completed. As discussed above, the time may be determined based on one or more organizational or representative scheduling preferences.

In some examples, the task includes a project or assignment for the representative to conduct alone. In such examples, the scheduling component 1314, based on determining the time for the task, may cause the task to be presented on the calendar at the time. In some examples, the task includes a meeting or other assignment for the representative to conduct with one or more other people, such as with a contact. In such examples, the scheduling component 1314 may send an invitation to the one or more other people for the task with the representative. Based on receiving an indication of acceptance of the invitation from at least one of the one or more other people, the scheduling component 1314 may cause the task to be presented on the calendar of the representative computing device. In examples with two or more other people, the scheduling component 1314 may determine a minimum number of required people to conduct the meeting. In some examples, the minimum number of required people may be determined based on the task data, organizational preferences, or contact data (e.g., data associated with the contact and/or an organization associated therewith). In such examples, the scheduling component 1314 may determine whether the minimum number of acceptances and/or each of the required people have accepted the invitation. Based on a determination that the minimum number of acceptances has been met and/or each of the required people have accepted the invitation, the scheduling component 1314 may cause the task to be presented on the representative computing device.

In some examples, the scheduling component 1314 may determine that the representative is scheduling or attempting to schedule another appointment at the time designated for the task (e.g., during a pending appointment, after invitations are sent, prior to acceptance). In some examples, the scheduling component 1314 may determine a second time for the appointment and may update the invitation to the one or more other people. In some examples, the scheduling component 1314 may determine that the second time is greater than a threshold amount of time before or after the originally scheduled time for the appointment. Based on the determination that the second time is greater than the threshold amount of time, the scheduling component 1314 may send a second invitation with the updated time to the one or more other users.

In various examples, the training component 1312 of the service computing device 1300 may access task data, contact data, organizational data, and/or representative data and may process the data to train one or more data model(s) 1320, such as data model(s) 134 of FIG. 1. In some examples, the data model(s) 1320 may be trained to determine groups of representatives. In some examples, the data model(s) 1320 may be trained to determine a particular representative of the group of representatives. In some examples, the data model(s) 1320 may be trained to determine a time associated with a calendar of an identified representative that may optimize performance of the task and/or efficiency of the representative. In some examples, the training component 1312 may utilize machine learning techniques to train the data model(s) 1320. Additionally or alternatively, the data model(s) 1320 may utilize one or more statistical models for processing data and determining an outcome.

Additional functional components may include an operating system 1322 for controlling and managing various functions of the service computing device 1300. The memory 1304 may also store other modules and data 1324, which may include programs, drivers, etc., and the data used or generated by the functional components, to enable efficient and effective food order processing. Further, the service computing device 1300 may include many other logical, programmatic and physical components, of which those described are merely examples that are related to the discussion herein. In addition, the memory 1304 may also store data, data structures and the like, that are used by the functional components.

The I/O interface(s) 1306, may include speakers, a microphone, a camera, and various user controls (e.g., buttons, a joystick, a keyboard, a keypad, etc.), a haptic output device, and so forth. The network interface(s) 1308 may include one or more interfaces and hardware components for enabling communication with various other devices over the network or directly. For example, network interface(s) 1308 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims. Furthermore, while techniques described herein are directed to techniques associated with scheduling services, similar techniques can be applicable for any type of services and should not be construed as being limited to only scheduling services.

We claim:

1. A method, implemented at least in part by a service computing device, the method comprising:
determining, by one or more processors, a task to be completed;
identifying, by the one or more processors, a group of representatives of an organization associated with performing the task;
determining, by the one or more processors, a representative of the group of representatives based at least in part on a scheduling model; and
causing, by the one or more processors, an appointment for the task to be presented at a representative computing device associated with the representative, the appointment being presented on a calendar associated with the representative.

2. The method of claim 1, further comprising:
determining a task type associated with the task; and
determining the scheduling model based at least in part on the task type associated with the task.

3. The method of claim 1, further comprising:
determining performance scores associated with respective representatives of the group of representatives; and
determining that a performance score associated with the representative is above a threshold,
wherein determining the representative is based at least in part on the performance score being above the threshold.

4. The method of claim 1, further comprising:
determining that the task is associated with a contact;
determining a time associated with the appointment;
sending, to a contact computing device associated with the contact, an invitation for the appointment at the time; and
receiving, from the contact computing device, an indication of acceptance of the invitation,
wherein causing the appointment for the task to be presented at the representative computing device associated with the representative is based at least in part on the indication of acceptance of the invitation.

5. The method of claim 1, further comprising:
receiving, from a computing device associated with an organization, task data associated with the task; and
determining a time associated with the task,
wherein determining the representative is based at least in part on the time associated with the task.

6. The method of claim 1, further comprising:
receiving, from a first computing device associated with a first user, a request for the task to be completed; and
determining a task type based at least in part on the request,
wherein the group of representatives is identified based at least in part on task type.

7. The method of claim 1, further comprising:
accessing an organizational profile associated with the organization;
determining that the organizational profile comprises the task to be completed during a time period; and
determining that a current time is within a threshold time of the time period,
wherein determining the task to be completed is based at least in part on the current time being within the threshold time of the time period.

8. A system comprising:
one or more processors; and
computer readable media storing instructions that, when executed, cause the system to perform operations comprising:
determining a task to be completed;
identifying a group of representatives of an organization associated with performing the task;
determining a representative of the group of representatives based at least in part on a performance score associated therewith; and
causing an appointment for the task to be presented at a representative computing device associated with the representative, the appointment being presented on a calendar associated with the representative.

9. The system of claim 8, the operations further comprising:
determining that the task is associated with a contact;
determining a time associated with the appointment;
sending, to a contact computing device associated with the contact, an invitation for the appointment at the time; and
receiving, from the contact computing device, an indication of acceptance of the invitation,
wherein causing the appointment for the task to be presented at the representative computing device associated with the representative is based at least in part on the indication of acceptance of the invitation.

10. The system of claim 8, wherein determining the representative of the group of representatives comprises:
determining historical performance data associated with the group of representatives;
determining, based on the historical performance data, respective performance scores associated with respective representatives of the group of representatives; and
determining that a first performance score associated with the representative is greater than a second performance score associated with another representative of the group of representatives.

11. The system of claim 8, wherein identifying the group of representatives comprises:
determining historical performance data corresponding to representatives associated with the organization;
determining, based on the historical performance data, respective performance scores associated with respective representatives associated with the organization; and
determining that one or more performance scores associated with one or more representatives is equal to or greater than a threshold performance score,
wherein the group of representatives comprises the one or more representatives having associated therewith one or more performance scores that are equal to or greater than the threshold performance score.

12. The system of claim 8, wherein identifying the group of representatives is based at least in part on at least one of:
a task type associated with the task;
performance scores associated with representatives of the group of representatives;
a scheduling model;
a calendar availability associated with each representative of the group of representatives; or
an organizational preference.

13. The system of claim 8, the operations further comprising:
receiving, from a contact computing device associated with a contact, a request for the task to be completed; and
determining a task type based at least in part on the request,
wherein the group of representatives is identified based at least in part on task type.

14. The system of claim 8, wherein identifying the representative if further based at least in part on a scheduling model.

15. One or more non-transitory computer readable media storing computer-executable instructions that, when executed by one or more processors of a computing device, cause the computing device to perform operations comprising:
determining a task to be completed;
identifying a group of representatives of an organization associated with performing the task;
determining a representative of the group of representatives based at least in part on at least one of a scheduling model or a performance score associated therewith; and
causing an appointment for the task to be presented at a representative computing device associated with the representative, the appointment being presented on a calendar associated with the representative.

16. The one or more non-transitory computer readable media of claim 15, wherein determining the representative of the group of representatives comprises:
determining historical performance data associated with the group of representatives;
determining, based on the historical performance data, respective performance scores associated with respective representatives of the group of representatives; and
determining that a first performance score associated with the representative is greater than a second performance score associated with another representative of the group of representatives.

17. The one or more non-transitory computer readable media of claim 15, wherein identifying the group of representatives comprises:
determining historical performance data corresponding to representatives associated with the organization;
determining, based on the historical performance data, respective performance scores associated with respective representatives associated with the organization; and
determining that one or more performance scores associated with one or more representatives is equal to or greater than a threshold performance score,
wherein the group comprises the one or more representatives having associated therewith one or more performance scores that are equal to or greater than the threshold performance score.

18. The one or more non-transitory computer readable media of claim 15, the operations further comprising:
receiving, from a contact computing device associated with a contact, a request for the task to be completed; and
determining a task type based at least in part on the request,
wherein the group of representatives is identified based at least in part on task type.

19. The one or more non-transitory computer readable media of claim 15, the operations further comprising:
accessing a database comprising an organizational profile associated with the organization;
determining that the organizational profile comprises the task to be completed during a time period; and
determining that a current time is within a threshold time of the time period,
wherein determining the task to be completed is based at least in part on the current time being within the threshold time of the time period.

20. The one or more non-transitory computer readable media of claim 15, the operations further comprising:
determining that the task is associated with a contact;
determining a time associated with the appointment;
sending, to a contact computing device associated with the contact, an invitation for the appointment at the time; and
receiving, from the contact computing device, an indication of acceptance of the invitation,
wherein causing the appointment for the task to be presented at the representative computing device associated with the representative is based at least in part on the indication of acceptance of the invitation.
